(19) United States
(12) Patent Application Publication
(10) Pub. No.: US 2013/0330710 A1
(43) Pub. Date: Dec. 12, 2013

(54) SILK BASED BIOPHOTONIC SENSORS

(71) Applicants: Fiorenzo Omenetto, Wakefield, MA (US); David Kaplan, Concord, MA (US); Jason Amsden, Boston, MA (US); Luca Dal Negro, Cambridge, MA (US)

(72) Inventors: Fiorenzo Omenetto, Wakefield, MA (US); David Kaplan, Concord, MA (US); Jason Amsden, Boston, MA (US); Luca Dal Negro, Cambridge, MA (US)

(73) Assignees: TRUSTEES OF BOSTON UNIVERSITY, Boston, MA (US); TUFTS UNIVERSITY, Medford, MA (US)

(21) Appl. No.: 13/813,288

(22) PCT Filed: Jul. 30, 2011
(86) PCT No.: PCT/US2011/046060

§ 371 Date: Aug. 29, 2013

Related U.S. Application Data
(60) Provisional application No. 61/369,402, filed on Jul. 30, 2010.

(51) Int. Cl. G01N 21/25

(52) U.S. Cl. CPC G01N 21/25
USPC 435/5; 435/7.2; 435/29; 435/34; 435/36; 435/7.1; 435/287.2; 435/288.7; 436/501; 436/171; 422/400

(57) ABSTRACT

The present disclosure relates to biophotonic sensors. An example of a biophotonic sensor may be an apparatus for analyzing a sample. The apparatus may include a substrate, aperiodic nanostructured protrusions disposed on the substrate, and a silk material deposited between the protrusions.

### RELATED APPLICATION

This application claims the benefit of U.S. provisional patent application 61/369,402, filed Jul. 30, 2010, entitled “Structural Color-Based Sensing in the Visible Regime,” the content of which is incorporated herein by reference in its entirety.

### GOVERNMENT SUPPORT

This invention was made with government support under grant No. W911NF-07-1-0618 awarded by the Defense Advanced Research Projects Agency (DARPA). The U.S. federal government has certain rights in the invention.

### BACKGROUND

Conventionally, the detection of features or surface variations on the nanoscale relies on sophisticated instrumentation such as: atomic force or electron microscopy, imaging based on dye-assisted spectroscopic techniques (Bake & Walt, 1 Annu. Rev. Anal. Chem. 515-47 (2008)), or collective resonant effects in plasmonic structures, such as sub-wavelength apertures (Stewart et al., 108 Chem. Rev. 494-521 (2008)), surface enhanced Raman scattering (Stiles et al., 1 Annu. Rev. Anal. Chem. 601-26 (2008)), or surface enhanced infrared absorption (Adato et al., 106 P. Natl. Acad. Sci. 19227-232 (2009)).

Light scattering phenomena in periodic systems, such as two-dimensional periodic lattices, (i.e., two-dimensional optical gratings), have also been explored for optics and photonics in current biosensing technology, which may provide label-free sensing of various molecular analytes and protein dynamics. Groisman et al., 16 Opt. Express 13499-508 (2008); Peng & Morris, 21 Opt. Lett. 549-11 (1996); Cunningham et al., 81 Sensors Actuat. B-Chem. 316-28 (2002); Lin et al., 17 Biosens. Bioelectron. 827-34 (2002); Lee & Fauchet, 15 Opt. Express 4530-35 (2007); Xiao & Mortensen, 1 J. Euro. Opt. Soc. 06026 (2006); Morhard et al., 97 Proc. Electrochem. Soc. 1058-65 (1997). While determining changes either in the intensity of diffracted light or in the frequency of optical resonances in response to changes in the refractive index of the surrounding environment (Amsden et al., 17 Opt. Express 21271-279 (2009)), periodic grating biosensors, however, rely on Bragg scattering. The Bragg scattering process, although providing frequency selective responses that are useful for colorimetric detection, intrinsically has limitations. For example, the ability of light waves to interact with adsorbed or chemically bound analytes present on the surface of these sensors is limited, since Bragg scattering is a first-order process in surface scattering perturbation theory (Tsang et al., “Scattering of electromagnetic waves,” John Wiley & Sons Inc., New York (2000); Maradudin, “Light scattering and nanoscale surface roughness,” Springer, New York (2007)), and scattered photons easily escape from a periodic surface within well defined spectral bands without prolonged interaction with the sensing layer. Therefore, there remains a need in the art to develop a sensing platform that is simple, cost-effective while providing enhanced sensitivity for label-free sensing, particularly relating to bio-sensing.

### SUMMARY OF THE INVENTION

Among other things, the present invention encompasses the recognition that silk-based materials provide a useful component for improved biophotonic sensors, as well as versatile assay platforms that incorporate such biophotonic sensors. In particular, the invention provides biophotonic sensors that incorporate a silk-based material in conjunction with aperiodic nanostructures upon a surface of the sensor. When such a surface is illuminated, the sensor scatters light according to a specific pattern (e.g., a “spectral signature”). The sensor may absorb, reflect, and/or diffract light to create the pattern. The pattern shifts or changes when the surface interacts with an analyte, which brings about local perturbation of light scattering, which forms the basis for the sensing assay system. Because the assay is based on nano-scale photonic sensing and involves a deterministic system (e.g., each surface configuration is associated with predictable “signature” scattering pattern), it allows a flexible means of processing and characterizing samples by a variety of parameters (e.g., multiplexing). The assay platform which incorporates certain aspects of the present invention as described herein is referred to as the “Smart-Slide” platform.

The inventors of the present application surprisingly discovered that incorporating a silk material to the surface of sensors that include nanostructures arranged according to aperiodic patterns enhanced the sensor's sensitivity. In some embodiments, a silk material is deposited around or between aperiodic nanostructures which form protrusions with respect to a substrate. The thickness of a silk material can vary, e.g., from about 1-10 nm. In some embodiments, a silk material deposited around the protrusions (e.g., nanostructures) of the detection surface incorporates one or more biological and/or chemical probes that interact with a target analyte. In some embodiments, a plurality of such detection surface units are arranged as a microarray upon a chip (e.g., micro-chip) for multiplex applications.

One aspect of the invention therefore relates to a biophotonic sensor for detecting or analyzing an analyte. The sensor comprises a substrate bearing deterministic, aperiodic nanostructured patterns and a biological interface comprising a silk material (e.g., silk fibroin monolayer) situated between the nanostructured patterns on the substrate. The surface of the biophotonic sensor is capable of producing a spectral signature when illuminated with a light source to indicate the presence of an analyte or the change of the analyte.

A “smart-slide” sensing platform was generated by combining silk fibroin with nanostructured aperiodic surfaces. This smart-slide sensing platform was based on distinctive color modifications observed using conventional scattering microscopy in the visible spectral range. The nanostructured aperiodic surfaces of the sensing platform provide the complex spatial patterns of critical modes suitable as a sensitive transduction mechanism, which can then reveal nanoscale variations of the surface topography. For example, a highly sensitive, label-free detection of such smart-slide was demonstrated by detecting an overt color change in response to the presence of a target analyte, e.g., protein, on the nanopatterned smart-slide.

Another aspect of the invention relates to an apparatus comprising a biophotonic slide; a light source that illuminates the biophotonic slide; a detector that receives spectral signatures scattered from the biophotonic slide when illuminated with the light source, and optionally, converts the received spectral signatures to a corresponding color image; and optionally, an image processing circuitry that recognizes or analyzes the spectral signatures to detect the presence or change of an analyte on the surface of the biophotonic slide. The biophotonic slide comprises a substrate bearing deterministic, aperiodic nanostructured patterns, and a biological interface comprising a silk material situated between the nanostructured patterns on the substrate.

Another aspect of the invention relates to a method of analyzing a sample, e.g., for detecting or analyzing an analyte. In some embodiments, described methods comprise the steps of obtaining a first spectral signature scattered from the surface of a biophotonic sensor, which comprises a substrate bearing deterministic, aperiodic nanostructured patterns, and a biological interface comprising a silk material situated between the nanostructured patterns on the substrate; exposing the biophotonic sensor to an analyte; obtaining a second spectral signature scattered from the surface of the biophotonic sensor; and determining the difference between the second and the first spectral signatures to detect or analyze the analyte. The method may further comprise monitoring the change of spectral signature scattered from the surface of the biophotonic sensor in response to the change of the analyte. The spectral signatures can be obtained through the steps of illuminating the biophotonic sensor with a light source; detecting a spectral signature scattered from the biophotonic sensor when illuminated with the light source; optionally, converting the detected spectral signature to a corresponding color image; and optionally, performing a pattern recognition or analysis on the spectral signature to detect the presence or change of an analyte on the surface of the biophotonic sensor.

The apparatus and methods described herein are useful for multiplex applications.

### BRIEF DESCRIPTION OF THE DRAWING

FIG. 1A is a schematic of the biophotonic smart-slide assembly illustrating the silk layer biointerface situated between the chromium nanoparticles. FIG. 1B is an SEM image of the aperiodic lattice. The Cr-nanoparticles are 40 nm tall with a diameter of 200 nm.

FIG. 2A is a dark-field image of the multispectral signature from the Gaussian-Prime nanopatterned lattice used in the biophotonic sensing device. The image was acquired by a multispectral CCD camera under white light illumination. FIG. 2B is an enlarged image of FIG. 2A showing a ˜5 μm×˜5 μm detail of the nanopatterned lattice. FIG. 2C is a graph depicting corresponding scattering response in two different locations of the nanoquilt measured from experiments.

FIG. 3 shows colorimetric responses as a function of increasing number of silk protein monolayers to modify the topography of the nanopatterned structure. The top diagram of FIG. 3 shows atomic force microscope measurements corresponding to the (1) nanopatterned surface, (2) nanopattered surface with a first silk monolayer and (3) an additional silk monolayer. FIGS. 3A and 3B show the detected images without any color correction and FIGS. 3C and 3D show the detected images by recoloring to display solely the spectral components centered at 510 and 590 nanometers. Comparison of FIGS. 3A and 3C (3A→3C) and FIGS. 3B and 3D (3B→3D) show the effect of addition of a single protein monolayer.

FIGS. 4A-4E show the results of the colorimetric fingerprints of periodic and aperiodic gratings. FIGS. 4A-4D are SEM images of two-dimensional periodic and aperiodic arrays of 100 nm-radius and 40 nm-high cylindrical Cr nanoparticles on a quartz substrate and the associated dark-field images illuminated at a grazing incidence with white light. The structural color patterns of the images vary by the N.A. of the imaging objective, in which different diffractive order is included into the collection cone. FIG. 4A shows the observation of periodic arrays under 10× objective with an 1 mm iris of N.A. reduced to 0.1. FIGS. 4B-4D show the observation of aperiodic arrays in Thue-Morse lattice (nearest center-to-center separation Λ=400 nm, FIG. 4B), Rudin-Shapiro lattice (Λ=400 nm, FIG. 4C), and Gaussian prime lattice (Λ=300 nm, FIG. 4D) under 50× objective with N.A. 0.5. The structural color patterns also vary by increasing the grating period with a progressive red-shift of the scattered wavelengths in FIG. 4A (clockwise from top-left). FIG. 4E is a schematic of the dark-field scattering setup used in the measurements.

FIGS. 5A-5F show the results of the colorimetric color formation in aperiodic arrays. FIGS. 5A-5D are images showing the results from calculated spatial field distributions (top view) of the scattered light in the plane of a Gaussian prime array of 100 nm-radius Cr nanospheres with 300 nm nearest center-to-center separation at Λ=630 nm (red) (FIG. 5A), Λ=520 nm (green) (FIG. 5B), Λ=470 nm (blue) (FIG. 5C); and FIG. 5D is a combined RGB image (the images were overlapped with weighted amplitudes to properly represent their spectral contributions). FIG. 5E is a graph showing the calculated scattering spectrum of the array illuminated by a plane wave at 75 degrees to normal. FIG. 5F is the corresponding measured image of the Gaussian prime nanoparticle array illuminated at a grazing incidence with white light.

FIGS. 6A-6F show the results of the colorimetric response as a function of monolayer deposition. FIGS. 6A-6D are multispectral dark-field images of Gaussian prime lattice (Λ=300 nm) coated with different thicknesses of silk protein monolayers at 0 nm (no) silk (FIG. 6A), 2 nm silk (FIG. 6B), 5 nm silk (FIG. 6C), and 20 nm silk (FIG. 6D) under white light illumination. FIG. 6E is a graph showing the colorimetric responses of coating different thicknesses of silk protein monolayers. The inset of FIG. 6E shows the AFM characterization of the arrays coated with different thickness of silk monolayers. FIG. 6F is a graph depicting that the sensitivity of the arrays was quantified by the spectral shift of the scattered radiation peaks PWS per thickness variation of the protein layer.

FIGS. 7A-7B show the results of the colorimetric response of periodic gratings as a function of monolayer deposition. FIG. 7A shows the dark-field images of periodic gratings with no silk, 2 nm of silk, and 20 nm of silk (from top to bottom). FIGS. 7B-7C show the scattering spectral responses of the gratings, with lattice constant of (1) 600 nm, and (2) 700 nm correspondingly, coated with different thicknesses of silk protein monolayers. No protein detection can be observed in the 2-5 nm thickness range, while a small shift in the spectral peak is observed when 20 nm thick layers are deposited on the 700 nm grating (FIG. 7C).

FIGS. 8A-8F show the results of autocorrelation analysis of structural pattern changes. FIGS. 8A-8D are dark-field images corresponding to one spectral color (622 nm) of Gaussian prime lattice (Λ=300 nm) with different thicknesses of silk protein monolayers of 0 nm (no) silk (FIG. 8A), 2 nm silk (FIG. 8B), 5 nm silk (FIG. 8C), and 20 nm silk (FIG. 8D) under white light illumination. FIG. 8E shows the analysis through one-dimensional ACF profiles extracted from two-dimensional normalized autocorrelation function along the x-axis of the middle of the corresponding images. FIG. 8F is a graph showing the changes of patterns due to different thicknesses of silk protein monolayers quantified by the normalized ACF variances.

FIG. 9 is an AFM image of a Thue-Morse arrays with 40 nm high, 100 nm radius Cr nanoparticles and minimum center-to-center interparticle separation of 400 nm.

FIGS. 10A-10D are dark-field scattering images of colorimetric fingerprints for Fibonacci (FIG. 10A), Penrose (FIG. 10B), Galois (FIG. 10C), (D) Co-Prime (FIG. 10D), Prime (FIG. 10E) and Ulam-Spiral (FIG. 10F) aperiodic arrays of 100 nm radius and 40 nm high cylindrical Cr nanoparticles on a quartz substrate.

FIGS. 11A-11C are graphs showing the calculated red-shifts of the peaks in the total scattering efficiency of Thue-Morse (FIG. 11A), Gaussian prime (FIG. 11B), and Rudin-Shapiro (FIG. 11C) aperiodic arrays of 200 nm-diameter Cr nanoparticles with the change of the ambient refractive index from n=1.0 to n=1.01 to n=1.02. The nearest center-to-center interparticle separation is 300 nm for the Gaussian prime array and 400 nm for Thue-Morse and Rudin-Shapiro arrays. The arrows indicate the wavelengths of the resonant peaks in the scattering spectra of the arrays in air.

FIGS. 12A-12I are images showing the in-plane field intensity distributions in the Thue-Morse (FIGS. 12A-12C), Gaussian prime (FIGS. 12D-12F), and Rudin-Shapiro (FIGS. 12G-121) arrays calculated at the corresponding resonant peak wavelengths for Δn=0 (indicated by arrows in FIG. 11) at λTM=405.2 nm (FIGS. 12A-12C), λgp=623.15 nm (FIGS. 12D-12F), and λRS=413.7 nm (FIGS. 12G-12I). FIG. 12J is a graph showing the change of the variances of the ACF of the calculated intensity distributions with the increase of the ambient refractive index.

FIG. 13 depicts a colorimetric sensor 1301 with nanostructures arranged in an aperiodic pattern on a surface 1303.

FIG. 14 depicts the replication of sensors with aperiodically patterned nanostructures on. PDMS thin films using a pattern transfer process.

FIG. 15 depicts a schematic of a process flow that can be used for hard mask nano-fabrication.

FIG. 16 depicts scanning electron microscope (SEM) images (a), (b), (c), and (d) at varying magnifications of PDMS surfaces with nanostructures.

FIG. 17 depicts space lattices of Thue-Morse and Rudin-Shapiro 2D photonic structures and their corresponding reciprocal space representations.

FIG. 18 depicts dark-field images of colorimetric signatures for sensors with aperiodically patterned structures.

FIG. 19 depicts colorimetric signatures for a sensor with chromium nanospheres arranged according to a Gaussian prime-based pattern.

FIG. 20 depicts far-field colorimetric signatures of a sensor with nanostructures arranged according to a Rudin-Shapiro pattern.

FIG. 21 depicts a spectral signature of a sensor with gold nano-particles arranged according to a Gaussian prime-based pattern before the sensor is exposed to analytes.

FIG. 22 depicts a spectral signature of the sensor of FIG. 21 after the sensor has been immersed in glucose solutions of varying concentrations.

FIGS. 23 and 24 depict patterns of scattered light for a sensor with gold nano-particles arranged according to a Gaussian prime-based pattern before and after exposure to glucose.

FIG. 25 depicts the variance in the fluctuations of the intensity distribution of scattered light patterns plotted as a function of the thickness of a layer of analytes on the sensor.

### DETAILED DESCRIPTION OF CERTAIN EMBODIMENTS OF THE INVENTION

The invention provided in the present application relates to a biophotonic sensor for detecting or analyzing an analyte. Sensors comprising aperiodic photonic structures are described in International Publication WO 2010/088585 A1 (“Chemical/Biological Sensor Employing Scattered Chromatic Components in Nano-Patterned Aperiodic Surfaces”) based on International Patent Application PCT/US2010/22701.

The present invention provides biosensors with improved sensitivity, and embodiments which are particularly suitable for use in detecting biological molecules (e.g., analytes). Biophotonic sensors according to the present invention comprise a substrate. The substrate bears nanostructures arranged according to deterministic, aperiodic patterns and a biological interface comprising a silk material (e.g., silk fibroin) situated between the nanostructures on the substrate. The biophotonic sensor is capable of producing a spectral signature when illuminated with a light source to indicate the presence of an analyte or the change of the analyte.

The biophotonic sensor of the present invention is characterized as follows. The sensor may include a substrate. The substrate may be comprised of any suitable material to provide a solid support. Non-limiting examples of suitable materials include, for example, a semiconductor material or a metal. In some embodiments, the substrate may include a low-index and/or high-index dielectric platform. In some embodiments, the substrate may include quartz.

In some embodiments, structures may be disposed on a surface of the substrate according to at least one aperiodic pattern. In some embodiments, structures may be disposed according to at least one aperiodic, deterministic pattern. In some embodiments, the structures may be protusions from the surface of the substrate. Exemplary structures may include nano-pillars, deposited particles, and/or nano-holes. The structures may have any shape, e.g., circular, cylindrical, elliptical, square, triangular. In some embodiments, the structures may be made of any material. For example, the structures may be made of metal, such as gold. In another example, the structures may be made of chromium. In some embodiments, different structures may be made of different materials.

In some embodiments, the distance between adjacent structures (e.g., the inter-structure distance) may be between about 50 nm and about 500 nm. The distance between adjacent structures may be between about 100 nm and about 300 nm. The distance between adjacent structures may be between about 300 nm and about 400 nm. In some embodiments, the distance may be measured from the centers of the structures. The distance may be measured from the boundaries of the structures. In some embodiments, the height of at least on nanostructure may be about 40 nm, although other values may be used. The radius of a nanostructure may be about 100 nm, although other values may be used. Silk may be deposited between the structures and/or on top of the structures, as described herein.

The sensor may be fabricated according to any fabrication technique, such as electron-beam lithography, ion-beam milling, or nano-imprint lithography. The fabrication may be replicated over a large surface area. In some embodiments, a sensor may be replicated on a soft polydimethylsiloxane (PDMS) or poly(methyl methacrylate) (PMMA) transparent polymer, such as a thin film. Room temperature nano-imprinting may be used for the replication. In some embodiments, a dimension of the sensor (e.g., diameter, edge) may be about 1 mm or less.

The aperiodic pattern of the structures may be any pattern that does not exhibit periodicity. In some embodiments, the aperiodic pattern does not exhibit translational periodicity. The aperiodic pattern may be generated by arranging structures according to simple determinstic algorithms based on the alternation of 1D deterministic aperiodic inflation rules (e.g., Fibonacci rule) along both orthogonal directions. In some embodiments, an aperiodic structure may be determined using automated global optimization techniques.

An aperiodic pattern may be based on Fibonacci, Thue-Morse, and/or Rudin-Shapiro sequences; Penrose lattices (e.g., Penrose tiling), prime number arrays, and/or L-systems, although other number systems may be used. Aperiodic patterns may be generated based on, for example, number-theoretic functions such as: co-prime function, Gaussian primes, Eisenstein's primes, Galois fields, primitive roots, quadratic residues sequences, Riemann's zeta, and L-functions. For example, a Thue-Morse array may be generated by a 2D generalization of the aperiodic inflation: A->AB, B->BA, where A and B represent the presence or absence of a structure. A Rudin-Shapiro array may be generated by iteration the following two-letter inflation: AA->AAAB, AB->AABA, BA->BBAB, BB->BBBA.

In some embodiments, the sensor may be enclosed in a dark box. The box may be compact. The box may include an aperture for receiving light to illuminate the sensor. The box may include an aperture for receiving light scattered by the sensor. In some embodiments, either aperture may include a magnifier.

A light source may be coupled to the aperture of the box. The light source may illuminate the sensor (e.g., project light onto the sensor). In some embodiments, the light source may project light onto the surface of the sensor. The beam of light may be directed perpendicular to the surface of the sensor. In some embodiments, the light source may project light at a grazing incidence relative to the surface of the sensor. The beam of light may be directed parallel to the surface.

In some embodiments, the light source may be projected onto the sensor at any angle. The light source may be adjustable to project the light at different angles. The angle at which light may be projected onto the sensor may be determined based on the design of the sensor (e.g., aperiodic pattern, materials), the wavelength(s) of light to project on the sensor, and/or the analyte that is being detected, by way of example. In some embodiments, the light source may be mounted on a pivot. The light source and pivot may be coupled to a computer. The computer may determine the angle at which the light may be projected based on the design of the sensor, the analyte being detected, and/or any other factor. The computer may actuate the pivot to rotate to the determined angle.

The light source may project light of any wavelength. In some embodiments, the light source may project white light. In some embodiments, the light source may project wide-spectrum light. Light from the light source may be coherent or incoherent. In some embodiments, the light source may be a source of super-continuum electromagnetic radiation. The light source may be a laser (e.g., solid-state laser, photonic crystal layer, semiconductor laser).

The sensor may scatter light from the light source. In some embodiments, the sensor may scatter the light within a dark-field microscope. The scattering may form a pattern of light. A camera (e.g., a charge-coupled device or CCD camera) may receive the pattern of light scattered by the sensor. The camera may process the pattern of light to generate a signal (e.g., an image of the scattered light). A computer processor may receive the signal from the camera and analyze the signal to determine the presence of an analyte.

A sensor with aperiodically patterned nanostructures may scatter light via diffraction and/or reflection, by way of example. The scattered light may exhibit a spectral signature associated with the sensor. Properties of the spectral signature may change in the presence of at least one analyte on a surface of the sensor.

In some examples, without wishing to be bound by theory, the index or indices of refraction at the surface of the sensor may impact the sensor's spectral signature. Analytes present on the sensor (e.g., on or in between the structures) may alter the refractive index of the surface. Due to the change in refractive index, light scattered by the sensor may exhibit a different spectral signature.

In some examples, without wishing to be bound by theory, quasi-stationary waves confined in structures of an aperiodic pattern may be formed by multiple scattering at several length scales within the sensor. When the angle of incidence of light projected onto the sensor and the frequency of the light achieve efficient coupling with the quasi-stationary waves, the frequency components of the sensor's spectral signature may exhibit broadband resonance features. As analytes may interfere with the interactions between the forms of electromagnetic radiation, light scattered by the sensor may exhibit a different spectral signature.

In some examples, without wishing to be bound by theory, a sensor may exhibit critical modes (e.g., high-Q critical modes). In some embodiments, the spectral signature of a sensor may include peaks inside a photonic bandgap associated with excitation of the critical modes. The critical modes of sensors with aperiodic patterns may be sensitive to changes in the index or indicies of refraction on the surface of the sensor. Thus, when analytes change the refractive index, light scattered by the sensor may exhibit a different spectral signature (e.g., exhibit at least one frequency shift).

The signature may be colorimetric. Colors of a spectral signature may be resonantly induced by multiple scattering of light by the sensor. In some embodiments, the signature may be indicative of broadband scattering. Features of the spectral signature may occur at any frequency. For example, features may occur in the visible range of electromagnetic radiation. Features may occur in the infrared range of electromagnetic radiation. The signature may be angularly, spectrally, and/or spatially resolved. The signature may include non-uniform angular distributions of scattered light. The signature and/or features of the signature may be localized. For example, the signature may be spatially localized.

The surface of the sensor with the aperiodically patterned nanostructures may be contacted with a sample, and the spectral signature of the sensor after the contact may be analyzed to determine if at least one analyte is present in the sample. In some embodiments, the sample may be a substance dissolved in solution (e.g., an aqueous solution). The sensor may be immersed in the solution. One or more drops of the solution may be dispensed onto the surface of the sensor. For example, a dropper may be used to dispense one or more drops of the solution on the surface of the sensor. A pipette may be used to dispense a predetermined amount of solution on the surface. In some embodiments, the sample may be a solid. Particles of the solid may be placed directly on the surface of the sensor. In some embodiments, the solid may be suspended in a material with adhesive properties (e.g., a tacky material). An amount of the material may be smeared on the sensor.

The presence of an analyte may be determined based on a change in one or more optical parameters of the spectral signature. For example, the presence of an analyte may be determined based on a change in the spatial color distribution of the sensor's spectral signature. In some embodiments, when an analyte is present on the sensor, the analyte changes the index of refraction of the sensor's surface. The combination of the analyte and the sensor may absorb and/or scatter light at different wavelengths than the wavelengths of light scattered by the sensor, acting alone. In some embodiments, a user of the sensor perceives one or more color changes regarding the visible light scattered by the sensor and analyte. For example, the sensor may scatter blue light when analytes are not present on its surface (e.g., a reference datum for the sensor). When an analyte is present, the analyte and sensor may scatter red light. In some embodiments, a user of the sensor perceives one or more changes in a spatial pattern for a wavelength of scattered light. For example, the sensor may scatter blue light according to a first pattern when analytes are not present on its surface. When analytes are present, the analytes and sensor may scatter blue light according to a second pattern.

In some embodiments, the spectral signature of a sensor may exhibit peaks. Peaks may be associated with one or more resonant responses of the sensor. Resonant peaks may be associated with back scattering. Resonant peaks may be associated with scattering cross sections for the sensor. Resonant peaks may be associated with the back-reflection resonance of the sensor. Any of the resonant peaks described herein may have narrow linewidths. In some embodiments, the presence of an analyte may be detected based on a change in a resonant spectral characteristic of a spectral signature. In some examples, a frequency shift of any of the resonant peaks described herein may indicate the presence of an analyte. In some examples, a frequency shift of a peak associated with excitation of a critical mode of the sensor may indicate the presence of an analyte. In some examples, the magnitude of the frequency shift may correspond to the amount of analyte present.

In some embodiments, the presence of an analyte may be determined according to a change in the intensity distribution of the sensor's spectral signature. The change in the intensity distribution may be determined based on correlation. The change may be determined based on 2D autocorrelation. In some embodiments, an image autocorrelation function (ACF) may be determined. For example, a value of the field intensity at point (x, y) in the array plane may be compared with the field intensity at another point (x′, y′) and mapped as a function of the distance between the two points. The variance in fluctuations of the intensity distribution function may be determined. In some embodiments, the variance may be the value of the properly normalized discrete ACF in the limit of zero lateral displacements.

A percentage change in the variance may indicate the presence of an analyte. In some examples, the percentage change must exceed a threshold to determine that the analyte is present. For example, the variance of a spectral signature's intensity distribution may need to increase by at least 4% to indicate that hemoglobin is present. The variance of a spectral signature's intensity distribution may need to increase by at least 8% to indicate that glucose is present. In some examples, the percentage change must fall within a predetermined range to indicate that the analyte is present. If the variance changes between 4% and 7%, hemoglobin may be present. If the variance exceeds 7%, the change in the spectral signature may be attributed to a different analyte. In another example, if the variance changes between 8% and 12%, the change may be attributed to the presence of glucose.

In some embodiments, the changes described herein may be used in any combination to determine the presence of an analyte. For example, the presence of glucose may change the spatial pattern of light scattered by the glucose and sensor. While the sensor, acting alone, may scatter blue light, the glucose and sensor, in combination, may scatter red light instead of blue light. The presence of glucose may change the variance of the intensity distribution of the spectral signature by 9%. Thus, a user of the system may determine that glucose is present based on any combination of the changes described herein.

In some embodiments, a “smart-slide” sensing platform was generated by combining photonics technology and biopolymer engineering, i.e., combining nanopatterned aperiodic surfaces with deterministic light scattering signatures, along with controllable deposition of nanoscale silk layers.

The incident light directed on the surface of the biophotonic sensor can be electromagnetic waves at any wavelength, with or without polarization. In some embodiments, the light source is a white light.

The spectral signature associated with changes in the surface topography of the biological interface can be detected in the visible range providing a convenient operational wavelength. For example, the detection of the spectral signature can employ dark-field microscopy.

In some embodiments, the spectral signature is a colorimetric spatial distribution pattern.

The biological interface comprises biological materials such as proteins situated (e.g., deposited) between the nanostructured patterns on the substrate. Depending on the height of the elements for the nanostructured patterns and the wavelength of the incident light, the protein layers (e.g., silk material) may be ultrathin, ranging from about 1 nm to 10 nm, or about 2 nm to 5 nm, inclusive.

In some embodiments, any biocompatible and/or biodegradable polymers with excellent optical properties may be used. In some embodiments, any polymer whose transmission in the visible spectrum exceeds 90% may be used. In some embodiments, any polymer whose optical transparency may be comparable to the transparency of silk materials may be used. Exemplary biopolymers with excellent optical properties include chitosan, collagen, gelatin, agarose, chitin, polyhydroxyalkanoates, pullan, starch (amylose amylopectin), cellulose, alginate, fibronectin, keratin, hyaluronic acid, pectin, polyaspartic acid, polylysin, pectin, dextrans, and related biopolymers, or a combination thereof. Exemplary biopolymers include polyethylene oxide, polyethylene glycol, polylactic acid, polyglycolic acid, polycaprolactone, polyorthoester, polycaprolactone, polyfumarate, polyanhydrides, and/or related copolymers.

In some embodiments, a biocompatible and/or biodegrdable polymer may be blended with a silk fibroin solution and deposited on the substrate of the sensor. The biopolymer may be processed in water and/or blended with silk fibroin.

In some embodiments, therefore, the thickness of the silk material deposited between the aperiodic nanostructures described herein is about 0.5 nm, about 1.0 nm, about 2.0 nm, about 3.0 nm, about 4.0 nm, about 5.0 nm, about 6.0 nm, about 7.0 nm, about 8.0 nm, about 9.0 nm, about 10 nm, about 11 nm, about 12 nm or greater. The protein layers interface such as silk material can contain a single protein layer (e.g., a silk fibroin monolayer), or multiple layers of protein or proteins, which may or may not be the same proteins. The protein layers can be in a controlled fashion deposited on the nanostructured patterns on the substrate; and when multiple protein monolayers are deposited, the thickness of protein layers can increase with a nanometer increment at each time.

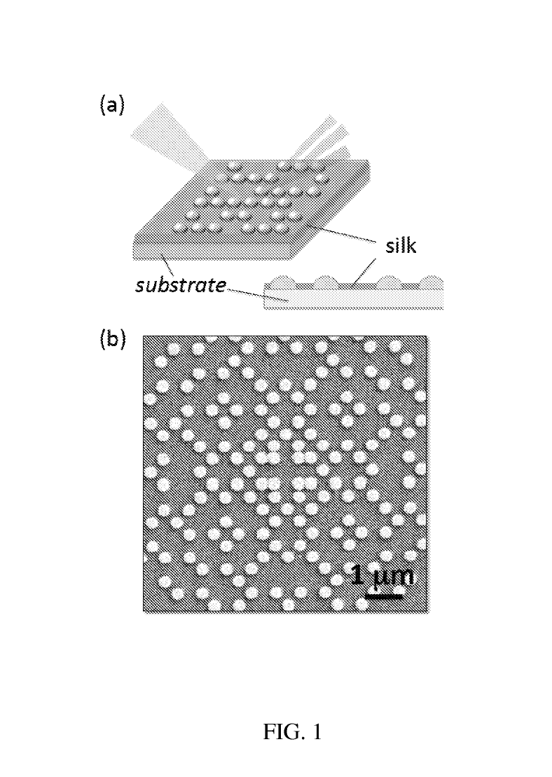

The present invention is based at least on the finding that the use of silk protein allows for the manufacture of functionalized nanostructures based on deterministic, aperiodic patterns and multispectral colorimetric signatures. Purified silk extracted from silk fibers has been recently introduced as a biopolymer material platform for photonics (Amsden et al., 22 Adv. Mater. 1-4 (2010)) and has been shown to interface with nanophotonic and optoelectronic devices because of its remarkable mechanical properties, optical clarity and the capacity to control the material features, including morphology down to single protein monolayers. Adato et al., 2009; Amsden et al., 2010; Amsden et al., 17 Opt. Express Adv. Mater. 21271-279 (2009); Lawrence et al., 9 Biomacromolecules 1214-20 (2008); Omenetto & Kaplan, 2 Nat. Photon. 641-43 (2008); Jiang et al., 17 Adv. Funct. Mater. 2229-37 (2007); Schroeder, “Number Theory in Science & Communication,” Springer-Verlag (1985). These properties can be incorporated into a smart-slide assembly by depositing (e.g., spin-coating) a thin layer of purified silk onto a nanoparticle lattice (See, e.g., FIGS. 1A and 1B).

As used herein, the term “silk fibroin” includes silkworm fibroin and insect or spider silk protein. See e.g., Lucas et al., 13 Adv. Protein Chem. 107 (1958). For example, silk fibroin useful for the present invention may be that produced by a number of species, including, without limitation: Antheraea mylitta; Antheraea pernyi; Antheraea yamamai; Galleria mellonella; Bombyx mori; Bombyx mandarina; Galleria mellonella; Nephila clavipes; Nephila senegalensis; Gasteracantha mammosa; Argiope aurantia; Araneus diadematus; Latrodectus geometricus; Araneus bicentenarius; Tetragnatha versicolor; Araneus ventricosus; Dolomedes tenebrosus; Euagrus chisoseus; Plectreurys tristis; Argiope trifasciata; and Nephila madagascariensis.

In general, silk for use in accordance with the present invention may be produced by any such organism, or may be prepared through an artificial process, for example, involving genetic engineering of cells or organisms to produce a silk protein and/or chemical synthesis. In some embodiments of the present invention, silk is produced by the silkworm, Bombyx mori.

As is known in the art, silks are modular in design, with large internal repeats flanked by shorter (˜100 amino acid) terminal domains (N and C termini). Silks have high molecular weight (200 to 350 kDa or higher) with transcripts of 10,000 base pairs and higher and >3000 amino acids (reviewed in Omenatto and Kaplan (2010) Science 329: 528-531). The larger modular domains are interrupted with relatively short spacers with hydrophobic charge groups in the case of silkworm silk. N- and C-termini are involved in the assembly and processing of silks, including pH control of assembly. The N- and C-termini are highly conserved, in spite of their relatively small size compared with the internal modules.

Table 1, below, provides an exemplary list of silk-producing species and silk proteins:

TABLE 1
An exemplary list of silk-producing species and
silk proteins (adopted from Bini et al.
(2003), J. Mol. Biol. 335(1): 27-40).
A. Silkworms

| | | Producing | |
|---|---|---|---|
| Accession | Species | gland | Protein |
| AAN28165 | Antheraea | Salivary | Fibroin |
| | mylitta | | |
| AAC32606 | Antheraea | Salivary | Fibroin |
| | pernyi | | |
| AAK83145 | Antheraea | Salivary | Fibroin |
| | yamamai | | |
| AAG10393 | Galleria | Salivary | Heavy-chain |
| | mellonella | | fibroin |
| | | | (N-terminal) |
| AAG10394 | Galleria | Salivary | Heavy-chain |
| | mellonella | | fibroin |
| | | | (C-terminal) |
| P05790 | Bombyx | Salivary | Fibroin heavy |
| | mori | | chain precursor, |
| | | | Fib-H, H-fibroin |
| CAA27612 | Bombyx | Salivary | Fibroin |
| | mandarina | | |
| Q26427 | Galleria | Salivary | Fibroin light |
| | mellonella | | chain precursor, |
| | | | Fib-L, L-fibroin, |
| | | | PG-1 |
| P21828 | Bombyx | Salivary | Fibroin light |
| | mori | | chain precursor, |
| | | | Fib-L, L-fibroin |

B. Spiders

| | | Producing | |
|---|---|---|---|
| Accession | Species | gland | Protein |
| P19837 | Nephila | Major | Spidroin 1, |
| | clavipes | ampullate | dragline silk |
| | | | fibroin 1 |
| P46804 | Nephila | Major | Spidroin 2, |
| | clavipes | ampullate | dragline silk |
| | | | fibroin 2 |
| AAK30609 | Nephila | Major | Spidroin 2 |
| | senegalensis | ampullate | |
| AAK30601 | Gasteracantha | Major | Spidroin 2 |
| | mammosa | ampullate | |
| AAK30592 | Argiope | Major | Spidroin 2 |
| | aurantia | ampullate | |
| AAC47011 | Araneus | Major | Fibroin-4, |
| | diadematus | ampullate | ADF-4 |
| AAK30604 | Latrodectus | Major | Spidroin 2 |
| | geometricus | ampullate | |
| AAC04503 | Araneus | Major | Spidroin 2 |
| | bicentenarius | ampullate | |
| AAK30615 | Tetragnatha | Major | Spidroin 1 |
| | versicolor | ampullate | |
| AAN85280 | Araneus | Major | Dragline silk |
| | ventricosus | ampullate | protein-1 |
| AAN85281 | Araneus | Major | Dragline silk |
| | ventricosus | ampullate | protein-2 |
| AAC14589 | Nephila | Minor | MiSp1 silk |
| | clavipes | ampullate | protein |
| AAK30598 | Dolomedes | Ampullate | Fibroin 1 |
| | tenebrosus | | |
| AAK30599 | Dolomedes | Ampullate | Fibroin 2 |
| | tenebrosus | | |
| AAK30600 | Euagrus | Combined | Fibroin 1 |
| | chisoseus | | |
| AAK30610 | Plectreurys | Larger | Fibroin 1 |
| | tristis | ampule- | |
| | | shaped | |
| AAK30611 | Plectreurys | Larger | Fibroin 2 |
| | tristis | ampule- | |
| | | shaped | |
| AAK30612 | Plectreurys | Larger | Fibroin 3 |
| | tristis | ampule- | |
| | | shaped | |
| AAK30613 | Plectreurys | Larger | Fibroin 4 |
| | tristis | ampule- | |
| | | shaped | |
| AAK30593 | Argiope | Flagelliform | Silk protein |
| | trifasciata | | |
| AAF36091 | Nephila | Flagelliform | Fibroin, silk |
| | madagascariensis | | protein |
| | | | (N-terminal) |
| AAF36092 | Nephila | Flagelliform | Silk protein |
| | madagascariensis | | (C-terminal) |
| AAC38846 | Nephila | Flagelliform | Fibroin, silk |
| | clavipes | | protein |
| | | | (N-terminal) |
| AAC38847 | Nephila | Flagelliform | Silk protein |
| | clavipes | | (C-terminal) |

Fibroin is a type of structural protein produced by certain spider and insect species that produce silk. Cocoon silk produced by the silkworm, Bombyx mori, is of particular interest because it offers low-cost, bulk-scale production suitable for a number of commercial applications, such as textile.

Silkworm cocoon silk contains two structural proteins, the fibroin heavy chain (˜350 k Da) and the fibroin light chain (˜25 k Da), which are associated with a family of non-structural proteins termed sericin, which glue the fibroin brins together in forming the cocoon. The heavy and light chains of fibroin are linked by a disulfide bond at the C-terminus of the two subunits (Takei, F., Kikuchi, Y., Kikuchi, A., Mizuno, S. and Shimura, K. (1987) J. Cell Biol., 105, 175-180; Tanaka, K., Mori, K. and Mizuno, S. (1993) J. Biochem. (Tokyo), 114, 1-4; Tanaka, K., Kajiyama, N., Ishikura, K., Waga, S., Kikuchi, A., Ohtomo, K., Takagi, T. and Mizuno, S. (1999) Biochim. Biophys. Acta, 1432, 92-103; Y Kikuchi, K Mori, S Suzuki, K Yamaguchi and S Mizuno, Structure of the Bombyx mori fibroin light-chain-encoding gene: upstream sequence elements common to the light and heavy chain, Gene 110 (1992), pp. 151-158). The sericins are a high molecular weight, soluble glycoprotein constituent of silk which gives the stickiness to the material. These glycoproteins are hydrophilic and can be easily removed from cocoons by boiling in water.

As used herein, the term “silk fibroin” refers to silk fibroin protein, whether produced by silkworm, spider, or other insect, or otherwise generated (Lucas et al., Adv. Protein Chem., 13: 107-242 (1958)). In some embodiments, silk fibroin is obtained from a solution containing a dissolved silkworm silk or spider silk. For example, in some embodiments, silkworm silk fibroins are obtained, from the cocoon of Bombyx mori. In some embodiments, spider silk fibroins are obtained, for example, from Nephila clavipes. In the alternative, in some embodiments, silk fibroins suitable for use in the invention are obtained from a solution containing a genetically engineered silk harvested from bacteria, yeast, mammalian cells, transgenic animals or transgenic plants. See, e.g., WO 97/08315 and U.S. Pat. No. 5,245,012, each od which is incorporated herein as reference in its entirety.

Thus, in some embodiments, a silk solution is used to fabricate compositions of the present invention contain fibroin proteins, essentially free of sericins. In some embodiments, silk solutions used to fabricate various compositions of the present invention contain the heavy chain of fibroin, but are essentially free of other proteins. In other embodiments, silk solutions used to fabricate various compositions of the present invention contain both the heavy and light chains of fibroin, but are essentially free of other proteins. In certain embodiments, silk solutions used to fabricate various compositions of the present invention comprise both a heavy and a light chain of silk fibroin; in some such embodiments, the heavy chain and the light chain of silk fibroin are linked via at least one disulfide bond. In some embodiments where the heavy and light chains of fibroin are present, they are linked via one, two, three or more disulfide bonds.

Although different species of silk-producing organisms, and different types of silk, have different amino acid compositions, various fibroin proteins share certain structural features. A general trend in silk fibroin structure is a sequence of amino acids that is characterized by usually alternating glycine and alanine, or alanine alone. Such configuration allows fibroin molecules to self-assemble into a beta-sheet conformation. These “Ala-rich” hydrophobic blocks are typically separated by segments of amino acids with bulky side-groups (e.g., hydrophilic spacers).

In some embodiments, core repeat sequences of the hydrophobic blocks of fibroin are represented by the following amino acid sequences and/or formulae:

(SEQ ID NO: 1)
(GAGAGS)₅₋₁₅;
(SEQ ID NO: 2)
(GX)₅₋₁₅;
(X = V, I, A)
(SEQ ID NO: 3)
GAAS;
(SEQ ID NO: 4)
(S₁₋₂A₁₁₋₁₃);
(SEQ ID NO: 5)
GX₁₋₄ GGX;
(SEQ ID NO: 6)
GGGX;
(X = A, S, Y, R, D V, W, R, D)
(SEQ ID NO: 7)
(S₁₋₂A₁₋₄)₁₋₂;
(SEQ ID NO: 8)
GLGGLG;
(SEQ ID NO: 9)
GXGGXG;
(X = L, I, V, P)
GPX;
(X = L, Y, I)
(SEQ ID NO: 10)
(GP(GGX)₁₋₄ Y)n;
(X = Y, V, S, A)
(SEQ ID NO: 11)
GRGGAn;
GGXn
(X = A, T, V, S);
(SEQ ID NO: 12)
GAG(A)₆₋₇GGA;
and
(SEQ ID NO: 13)
GGX GX GXX.
(X = Q, Y, L, A, S, R)

In some embodiments, a fibroin peptide contains multiple hydrophobic blocks, e.g., 3, 4, 5, 6, 7, 8, 9, 10, 11, 12, 13, 14, 15, 16, 17, 18, 19 and 20 hydrophobic blocks within the peptide. In some embodiments, a fibroin peptide contains between 4-17 hydrophobic blocks.

In some embodiments of the invention, a fibroin peptide comprises at least one hydrophilic spacer sequence (“hydrophilic block”) that is about 4-50 amino acids in length. Non-limiting examples of the hydrophilic spacer sequences include:

(SEQ ID NO: 14)
TGSSGFGPYVNGGYSG;
(SEQ ID NO: 15)
YEYAWSSE;
(SEQ ID NO: 16)
SDFGTGS;
(SEQ ID NO: 17)
RRAGYDR;
(SEQ ID NO: 18)
EVIVIDDR;
(SEQ ID NO: 19)
TTIIEDLDITIDGADGPI
and
(SEQ ID NO: 20)
TISEELTI.

In certain embodiments, a fibroin peptide contains a hydrophilic spacer sequence that is a derivative of any one of the representative spacer sequences listed above. Such derivatives are at least 75%, at least 80%, at least 85%, at least 90%, or at least 95% identical to any one of the hydrophilic spacer sequences.

In some embodiments, a fibroin peptide suitable for the present invention contains no spacer.

As noted, silks are fibrous proteins and are characterized by modular units linked together to form high molecular weight, highly repetitive proteins. These modular units or domains, each with specific amino acid sequences and chemistries, are thought to provide specific functions. For example, sequence motifs such as poly-alanine (polyA) and poly-alanine-glycine (poly-AG) are inclined to be beta-sheet-forming; GXX motifs contribute to 31-helix formation; GXG motifs provide stiffness; and, GPGXX (SEQ ID NO: 22) contributes to beta-spiral formation. These are examples of key components in various silk structures whose positioning and arrangement are intimately tied with the end material properties of silk-based materials (reviewed in Omenetto and Kaplan (2010) Science 329: 528-531).

It has been observed that the beta-sheets of fibroin proteins stack to form crystals, whereas the other segments form amorphous domains. It is the interplay between the hard crystalline segments, and the strained elastic semi amorphous regions, that gives silk its extraordinary properties. Non-limiting examples of repeat sequences and spacer sequences from various silk-producing species are provided in Table 2 below.

TABLE 2
Hydrophobic and hydrophilic components of fibroin sequences (adopted from Bini et al.
(2003), J. Mol. Biol. 335(1): 27-40).

| | Hydrophilic blocks | | | Hydrophobic blocks | | |
|---|---|---|---|---|---|---|
| | N- | C- | Hydrophilic spacer | | | |
| | term | term | (aa) & representative | Range, | # of | |
| Species | aa | aa | sequence | aa | Blocks | Core repeat sequences |

A. Lepidoptera (Heavy chain fibroin)

| | | | | | | |
|---|---|---|---|---|---|---|
| Bombyx mori | 151 | 50 | 32-33, | 159-607 | 12 | (GAGAGS)₅₋₁₅, (SEQ ID NO: 1); |
| | | | GSSGFGPYVNGGYSG, | | | (GX)₅₋₁₅ (X = V, I, A), |
| | | | (SEQ ID NO: 14) | | | (SEQ ID NO: 2); |
| | | | | | | GAAS (SEQ ID NO: 3) |
| Bombyx mandarina | 151 | | YAWSSE, | | | |
| | | | (SEQ ID NO: 15) | | | |
| Antheraea mylitta | 86 | | SDFGTGS, | | | |
| | | | (SEQ ID NO: 16) | | | |
| Antheraea pernyi | 87 | 32 | | | | |
| Antheraea yamamai | 87 | 32 | 7, RRAGYDR, | 140-340 | 16 | (S₁₋₂A₁₁₋₁₃), (SEQ ID NO: 4); |
| | | | (SEQ ID NO: 17) | | | GX₁₋₄ GGX, (SEQ ID NO: 5); |
| | | | | | | GGGX (X = A, S, Y, R, D V, W, |
| | | | | | | R, D), (SEQ ID NO: 6) |
| Galleria mellonella | 189 | 60 | 6-8, EVIVIDDR, | 75-99 | 13 | (S₁₋₂A₁₋₄)₁₋₂, (SEQ ID NO: 7); |
| | | | (SEQ ID NO: 18) | | | GLGGLG, (SEQ ID NO: 8); |
| | | | | | | GXGGXG (X = L, I, V, P), |
| | | | | | | (SEQ ID NO: 9); |
| | | | | | | GPX (X = L, Y, I) |

B. Arachnida

| | | | | | | |
|---|---|---|---|---|---|---|
| Nephila clavipes | 115 | 89 | | | | |
| Nephila | 115 | 89 | 26, TTIIEDLDITIDG | 260-380 | 5 | (GP(GGX)1-4 Y)n |
| madascariensis | | | ADGPI, | | | (X = Y, V, S, A), |
| | | | (SEQ ID NO: 19) | | | (SEQ ID NO: 10) |
| Argiope trifasciata | | 113 | | | | GRGGAn, (SEQ ID NO: 11) |
| | | | | | | GGXn (X = A, T, V, S) |
| Major ampullata | | | TISEELTI, | | | |
| | | | (SEQ ID NO: 20) | | | |
| Nephila clavipes | | 97 | No spacer | 19-46 | | GAG(A)₆₋₇GGA, (SEQ ID NO: 12); |
| | | | | | | GGX GX GXX(X = Q, Y, L, A, |
| | | | | | | S, R), (SEQ ID NO: 13) |
| Gasteracantha | | 89 | No spacer | | | |
| mammosa | | | | | | |
| Argiope aurantia | | 82 | No spacer | | | |
| Nephila | | 82 | No spacer | | | |
| senegalensis | | | | | | |
| Latrodectus | | 8 | No spacer | | | |
| geometricus | | | | | | |
| Aaneus diadematus | | 94 | No spacer | | | |

The particular silk materials explicitly exemplified herein were typically prepared from material spun by silkworm, B. Mori. Typically, cocoons are boiled for ˜30 min in an aqueous solution of 0.02M Na₂CO₃, then rinsed thoroughly with water to extract the glue-like sericin proteins. The extracted silk is then dissolved in LiBr (such as 9.3 M) solution at room temperature, yielding a 20% (wt.) solution. The resulting silk fibroin solution can then be further processed for a variety of applications as described elsewhere herein. Those of ordinary skill in the art understand other sources available and may well be appropriate, such as those exemplified in the Table above.

The complete sequence of the Bombyx mori fibroin gene has been determined (C.-Z Zhou, F Confalonieri, N Medina, Y Zivanovic, C Esnault and T Yang et al., Fine organization of Bombyx mori fibroin heavy chain gene, Nucl. Acids Res. 28 (2000), pp. 2413-2419). The fibroin coding sequence presents a spectacular organization, with a highly repetitive and G-rich (˜45%) core flanked by non-repetitive 5′ and 3′ ends. This repetitive core is composed of alternate arrays of 12 repetitive and 11 amorphous domains. The sequences of the amorphous domains are evolutionarily conserved and the repetitive domains differ from each other in length by a variety of tandem repeats of subdomains of ˜208 bp.

The silkworm fibroin protein consists of layers of antiparallel beta sheets whose primary structure mainly consists of the recurrent amino acid sequence (Gly-Ser-Gly-Ala-Gly-Ala)n (SEQ ID NO: 21). The beta-sheet configuration of fibroin is largely responsible for the tensile strength of the material due to hydrogen bonds formed in these regions. In addition to being stronger than Kevlar, fibroin is known to be highly elastic. Historically, these attributes have made it a material with applications in several areas, including textile manufacture.

Fibroin is known to arrange itself in three structures at the macromolecular level, termed silk I, silk II, and silk III, the first two being the primary structures observed in nature. The silk II structure generally refers to the beta-sheet conformation of fibroin. Silk I, which is the other main crystal structure of silk fibroin, is a hydrated structure and is considered to be a necessary intermediate for the preorganization or prealignment of silk fibroin molecules. In the nature, silk I structure is transformed into silk II structure after spinning process. For example, silk I is the natural form of fibroin, as emitted from the Bombyx mori silk glands. Silk II refers to the arrangement of fibroin molecules in spun silk, which has greater strength and is often used commercially in various applications. As noted above, the amino-acid sequence of the β-sheet forming crystalline region of fibroin is dominated by the hydrophobic sequence. Silk fibre formation involves shear and elongational stress acting on the fibroin solution (up to 30% wt/vol.) in the gland, causing fibroin in solution to crystallize. The process involves a lyotropic liquid crystal phase, which is transformed from a gel to a sol state during spinning—that is, a liquid crystal spinning process 1. Elongational flow orients the fibroin chains, and the liquid is converted into filaments.

Silk III is a newly discovered structure of fibroin (Valluzzi, Regina; Gido, Samuel P.; Muller, Wayne; Kaplan, David L. (1999). “Orientation of silk III at the air-water interface”. International Journal of Biological Macromolecules 24: 237-242). Silk III is formed principally in solutions of fibroin at an interface (i.e. air-water interface, water-oil interface, etc.).

Silk can assemble, and in fact can self-assemble, into crystalline structures. Silk fibroin can be fabricated into desired shapes and conformations, such as silk hydrogels (WO2005/012606; PCT/US08/65076), ultrathin films (WO2007/016524), thick films, conformal coatings (WO2005/000483; WO2005/123114), foams (WO 2005/012606), electrospun mats (WO 2004/000915), microspheres (PCT/US2007/020789), 3D porous matrices (WO2004/062697), solid blocks (WO2003/056297), microfluidic devices (PCT/US07/83646; PCT/US07/83634), electro-optical devices (PCT/US07/83639), and fibers with diameters ranging from the nanoscale (WO2004/000915) to several centimeters (U.S. Pat. No. 6,902,932). The above mentioned applications and patents are incorporated herein by reference in their entirety. For example, silk fibroin can be processed into thin, mechanically robust films with excellent surface quality and optical transparency, which provides an ideal substrate acting as a mechanical support for high-technology materials, such as thin metal layers and contacts, semiconductor films, dielectic powders, nanoparticles, and the like.

Unique physiochemical properties of silk allows its use in a variety of applications such as those described herein. For example, silk is stable, flexible and durable. Furthermore, useful silk materials can be prepared through processes that can be carried out at room temperature and are water-based. Therefore, bio-molecules of interest can be readily incorporated into silk materials and used as a “bait” to assay for an analyte of interest.

In addition, silk-based materials can be prepared to be smooth and/or adhesive at the molecular level. In some embodiments, silk-based materials provided by and/or utilized in accordance with the present invention are both smooth and adhesive at the molecular level. Silk-based materials showing molecular level smoothness and/or adhesiveness permit certain applications that are not possible with other materials. Smoothness/roughness plays an important role in determining how a real object will interact with its environment. In certain embodiments, silk-based materials provided by and/or used in accordance with the present invention have affinity for biological surfaces, e.g., cells and soft tissues. Moreover, silk-based materials provided by and/or utilized in accordance with certain embodiments of the present invention exhibit excellent adhesion to conductive materials, such as metal. The present invention embraces the recognition that certain silk materials can act as in interface between a biological element and a non-biological element (e.g., a photonic sensor element).

In accordance with certain embodiments of the invention, some provided silk-based materials can be prepared to show tackiness (e.g., stickability) when wet. This property, particularly when coupled with surface smoothness as described herein, can render certain silk materials uniquely suitable to serve as nano- and/or micro-scale adhesives that attach (e.g., glue) a non-biological element (e.g., photonic sensor substrate) with a biological surface in a way other matrices cannot.

While a number of types of silk fibroin, such as those exemplified above, may be used to practice the claimed invention, silk fibroin produced by silkworms, such as Bombyx mori, is the most common and represents an earth-friendly, renewable resource. For instance, silk fibroin may be attained by extracting sericin from the cocoons of B. mori. Organic silkworm cocoons are also commercially available. There are many different silks, however, including spider silk (e.g., obtained from Nephila clavipes), transgenic silks, genetically engineered silks, such as silks from bacteria, yeast, mammalian cells, transgenic animals, or transgenic plants (see, e.g., WO 97/08315; U.S. Pat. No. 5,245,012), and variants thereof, that may be used.

As already noted, an aqueous silk fibroin solution may be prepared using techniques known in the art. Suitable processes for preparing silk fibroin solution are disclosed, for example, in U.S. patent application Ser. No. 11/247,358; WO/2005/012606; and WO/2008/127401. The silk aqueous solution can then be processed into silk matrix such as silk films, conformal coatings or layers, or 3-dimensional scaffolds, or electrospun fibers. A micro-filtration step may be used herein. For example, the prepared silk fibroin solution may be processed further by centrifugation and syringe based micro-filtration before further processing into silk matrix. This process enables the production of silk fibroin solution of excellent optical quality and stability. The micro-filtration step may be desirable for the generation of high-quality optical films or monolayers.

Other biocompatible and biodegradable polymers may be blended in the silk protein layers. For example, additional biopolymers, such as chitosan, exhibit desirable mechanical properties, can be processed in water, blended with silk fibroin, and form generally clear films, conformational coating or layers for optical applications. Other biopolymers, such as chitosan, collagen, gelatin, agarose, chitin, polyhydroxyalkanoates, pullan, starch (amylose amylopectin), cellulose, alginate, fibronectin, keratin, hyaluronic acid, pectin, polyaspartic acid, polylysin, pectin, dextrans, and related biopolymers, or a combination thereof, may be utilized in specific applications, and synthetic biodegradable polymers such as polyethylene oxide, polyethylene glycol, polylactic acid, polyglycolic acid, polycaprolactone, polyorthoester, polycaprolactone, polyfumarate, polyanhydrides, and related copolymers may also be selectively used. The polymer selected herein to be blended into the silk protein layers should not negatively impact the optical quality or stability of silk protein layers.

According to the invention, silk-based biophotonic sensors provide enhanced sensitivity in detecting analyte of interest. In some embodiments, determination of the quantity or concentration of the analyte may be qualitatively or quantitatively monitored based on the change of the spectral signatures. The sensitivity of the biophotonic sensor in detecting the quantigy or concentration of the analyte can be, for example, about 10⁻⁹ mol/L, about 10⁻¹⁰ mol/L, about 10⁻¹¹ mol/L, about 10⁻¹² mol/L, about 10⁻¹³ mol/L, about 10⁻¹⁴ mol/L, about 10⁻¹⁵ mol/L, about 10⁻¹⁶ mol/L, about 10⁻¹⁷ mol/L, and as low as about 10⁻¹⁸ mol/L.

The silk interface of the biophotonic sensor may contain active agent or can be functionalized with an active group, as disclosed herein. In this regard, the active agent, or functionalized silk protein, may function as the “receptors” for the analyte applied on biophotonic sensor, where the interaction between the “receptors” and the analyte can be detected and analyzed by monitoring the spectral feature change of the biophotonic sensor. Optical parameters by which these changes are measured are described elsewhere herein.

According to the invention, as stated above, at least one agent may be added into silk material to be deposited onto the biophotonic sensor. Such agents may be added to provide any desired analytical information sought for particular use. In some embodiments, analytical information sought is determination of the presence or absence of one or more analytes (e.g., detection) in a test sample. In some embodiments, analytical information provides relative amounts/levels of one or more analytes in a test sample. In some embodiments, information pertaining to structural and/or conformational changes that occur to one or more analytes can also be obtained.

Such agent may be added into the silk fibroin solution before and/or during the processing of silk fibroin solution into silk protein layers. Additionally or alternatively, active agent may be coupled to the surface of the silk material after the silk material is deposited upon the surface of the sensor. For example, one or more agents may be chemically linked to the silk material that is deposited between nanostructures of the apparatus described herein. In some embodiments, silk material used to fabricate the biophotonic sensor of the present invention may incorporate one or more universal capturing moieties and/or tags, such as avidin, flag, His6, HA tag, etc. Any desired “bait” molecules that specifically interact with such a moiety/tag can then be added to the substrate to generate a user-specific assay system suitable for desired utility.

The active agent can represent any material capable of being embedded in or coupled/linked to the silk material. For example, the agent may be a therapeutic agent, or a biological material, such as cells (including stem cells), proteins, peptides, nucleic acids (e.g., DNA, RNA, siRNA), nucleic acid analogs, nucleotides, oligonucleotides, peptide nucleic acids (PNA), aptamers, antibodies or fragments or portions thereof (e.g., paratopes or complementarity-determining regions), antigens or epitopes, hormones, hormone antagonists, growth factors or recombinant growth factors and fragments and variants thereof; cell attachment mediators (such as RGD), cytokines, cytotoxins, enzymes, small molecules, drugs, dyes, amino acids, vitamins, antioxidants, antibiotics or antimicrobial compounds, anti-inflammation agents, antifungals, viruses, antivirals, toxins, prodrugs, chemotherapeutic agents, or combinations thereof. (See, e.g., PCT/US09/44117; PCT/US10/41615). The agent may also be a combination of any of the above-mentioned agents. Encapsulating either a therapeutic agent or biological material, or the combination of them, is desirous because the encapsulated product can be used for numerous biomedical purposes. Moreover, the active agent may include neurotransmitters, hormones, intracellular signal transduction agents, pharmaceutically active agents, toxic agents, agricultural chemicals, chemical toxins, biological toxins, microbes, and animal cells such as neurons, liver cells, and immune system cells. The active agents may also include therapeutic compounds, such as pharmacological materials, vitamins, sedatives, hypnotics, prostaglandins and radiopharmaceuticals.

In some embodiments, agents that function as biological indicators can be used in conjunction with the silk material, the presence of which can be detected and/or measured by one or more parameters described elsewhere herein. Additionally or alternatively, as described herein, the silk material used to fabricate a biophotonic sensor described herein may be activated to function as an indicator which provide analytical information either each by itself or collectively. In some embodiments, indicators to be measured or determined by the use of the biophotonic sensor of the invention include a wide variety of biological, physicochemical and microbiological indicators. These include but are not limited to: pH, pK, pI, ionic strength, gas content, sugar content, protein content, heterotrophic plate count (HPC), total coliforms (TC), fecal coliforms (FC), fecal streptococci (FS), sulfite-reducing clostridia (SRC), Pseudomonas aeruginosa, and Salmonella spp., ammonia, biological oxygen demand (BOD₅); chemical oxygen demand (COD); chloride; conductivity; suspended dissolved and total solids; fats; nitrate, nitrite, and total nitrogen; pH; phosphate and total phosphorus, total (TP) and soluble (SP) protein contents. These indicators are particularly suitable for monitoring environmental contaminants in a sample, such as water. For example, effectiveness of wastewater treatment may be monitored by determining the presence of certain contaminants such as those provided above, by the use of the biophotonic sensor of the present invention.

In addition, the invention may be used to detect the presence of toxins and/or bioterrorism agents. Exemplary bioterrorism agents include, without limitation: Bacillus anthracis, Clostridium botulinum toxin, Yersinia pestis, Variola major, Francisella tularensis, Arenaviruses (Lassa, Machupo), Bunyaviruses (Congo-Crimean, Rift Valley), Filoviruses (Ebola, Marburg), Brucella species, Coxiella burnetii, Chlamydia psittaci, Rickettsia prowazekii, Salmonella, Shigella, Escherichia coli 0157:H7, Burkholderia mallei, Burkholderia pseudomallei, Cryptosporidium parvum, Vibrio cholerae, Ricin toxin from Ricinus communis, Eastern equine encephalitis, Western equine encephalitis, and Venezuelan equine encephalitis.

In some embodiments, particularly in the context of diagnostic applications, biological indicators useful for the present invention include molecules associated with certain clinical indications. For example, infectious diseases involve the presence of infectious pathogens found in a biological sample collected from a subject, such as microorganisms known to cause an infection. In some embodiments, the active agent may also be an organism such as a fungus, plant, animal, bacterium, or a virus (including bacteriophage). Similarly, to detect or diagnose cancer, elevated levels of certain tumor-associated proteins and/or antibodies are known in the art. Therefore, these cancer-associated or tumor-associated factors can serve as indicators of the disease. Many other diseases and disorders also are known to be associated with abnormal levels of specific set of proteins, hormones, cytokines, chemokines, growth factors, antigens, antibodies, immune cell types, etc., each of which can, either by itself or in combination, serve to signal the manifestation or heightened risk of the disease or disorder. Thus, the invention described herein can be used to detect and/or monitor any of these indicators in a suitable sample to aid diagnosis and/or disease progression in patients.

Exemplary cells suitable for use herein may include, but are not limited to, progenitor cells or stem cells, smooth muscle cells, skeletal muscle cells, cardiac muscle cells, epithelial cells, endothelial cells, urothelial cells, fibroblasts, myoblasts, oscular cells, chondrocytes, chondroblasts, osteoblasts, osteoclasts, keratinocytes, kidney tubular cells, kidney basement membrane cells, integumentary cells, bone marrow cells, hepatocytes, bile duct cells, pancreatic islet cells, thyroid, parathyroid, adrenal, hypothalamic, pituitary, ovarian, testicular, salivary gland cells, adipocytes, and precursor cells. The active agents can also be the combinations of any of the cells listed above. See also WO 2008/106485; PCT/US2009/059547; WO 2007/103442.

Exemplary antibodies that may be incorporated in silk fibroin include, but are not limited to, abciximab, adalimumab, alemtuzumab, basiliximab, bevacizumab, cetuximab, certolizumab pegol, daclizumab, eculizumab, efalizumab, gemtuzumab, ibritumomab tiuxetan, infliximab, muromonab-CD3, natalizumab, ofatumumab omalizumab, palivizumab, panitumumab, ranibizumab, rituximab, tositumomab, trastuzumab, altumomab pentetate, arcitumomab, atlizumab, bectumomab, belimumab, besilesomab, biciromab, canakinumab, capromab pendetide, catumaxomab, denosumab, edrecolomab, efungumab, ertumaxomab, etaracizumab, fanolesomab, fontolizumab, gemtuzumab ozogamicin, golimumab, igovomab, imciromab, labetuzumab, mepolizumab, motavizumab, nimotuzumab, nofetumomab merpentan, oregovomab, pemtumomab, pertuzumab, rovelizumab, ruplizumab, sulesomab, tacatuzumab tetraxetan, tefibazumab, tocilizumab, ustekinumab, visilizumab, votumumab, zalutumumab, and zanolimumab. The active agents can also be the combinations of any of the antibodies listed above.

Exemplary antibiotic agents include, but are not limited to, actinomycin; aminoglycosides (e.g., neomycin, gentamicin, tobramycin); β-lactamase inhibitors (e.g., clavulanic acid, sulbactam); glycopeptides (e.g., vancomycin, teicoplanin, polymixin); ansamycins; bacitracin; carbacephem; carbapenems; cephalosporins (e.g., cefazolin, cefaclor, cefditoren, ceftobiprole, cefuroxime, cefotaxime, cefipeme, cefadroxil, cefoxitin, cefprozil, cefdinir); gramicidin; isoniazid; linezolid; macrolides (e.g., erythromycin, clarithromycin, azithromycin); mupirocin; penicillins (e.g., amoxicillin, ampicillin, cloxacillin, dicloxacillin, flucloxacillin, oxacillin, piperacillin); oxolinic acid; polypeptides (e.g., bacitracin, polymyxin B); quinolones (e.g., ciprofloxacin, nalidixic acid, enoxacin, gatifloxacin, levaquin, ofloxacin, etc.); sulfonamides (e.g., sulfasalazine, trimethoprim, trimethoprim-sulfamethoxazole (co-trimoxazole), sulfadiazine); tetracyclines (e.g., doxycyline, minocycline, tetracycline, etc.); monobactams such as aztreonam; chloramphenicol; lincomycin; clindamycin; ethambutol; mupirocin; metronidazole; pefloxacin; pyrazinamide; thiamphenicol; rifampicin; thiamphenicl; dapsone; clofazimine; quinupristin; metronidazole; linezolid; isoniazid; piracil; novobiocin; trimethoprim; fosfomycin; fusidic acid; or other topical antibiotics. Optionally, the antibiotic agents may also be antimicrobial peptides such as defensins, magainin and nisin; or lytic bacteriophage. The antibiotic agents can also be the combinations of any of the agents listed above. See also PCT/US2010/026190.

Exemplary enzymes include, but are not limited to, peroxidase, lipase, amylose, organophosphate dehydrogenase, ligases, restriction endonucleases, ribonucleases, DNA polymerases, glucose oxidase, laccase, and the like. Interactions between components may also be used to functionalize silk fibroin through, for example, specific interaction between avidin and biotin. The active agents can also be the combinations of any of the enzymes listed above. When introducing therapeutic agents or biological material into the silk protein layers, other materials known in the art may also be added with the agent. For instance, it may be desirable to add materials to promote the growth of the agent (for biological materials), promote the functionality of the agent after it is released from the silk layers, or increase the agent's ability to survive or retain its efficacy during the period it is embedded in the silk. Materials known to promote cell growth include cell growth media, such as Dulbecco's Modified Eagle Medium (DMEM), fetal bovine serum (FBS), non-essential amino acids and antibiotics, and growth and morphogenic factors such as fibroblast growth factor (FGF), transforming growth factors (TGFs), vascular endothelial growth factor (VEGF), epidermal growth factor (EGF), insulin-like growth factor (IGF-I), bone morphogenetic growth factors (BMPs), nerve growth factors, and related proteins may be used. Growth factors are known in the art, see, e.g., Rosen & Thies, Cellular & Molecular Basis Bone Formation & Repair (R. G. Landes Co., Austin, Tex., 1995). Additional options for delivery via the silk include DNA, siRNA, antisense, plasmids, liposomes and related systems for delivery of genetic materials; peptides and proteins to activate cellular signaling cascades; peptides and proteins to promote mineralization or related events from cells; adhesion peptides and proteins to improve film-tissue interfaces; antimicrobial peptides; and proteins and related compounds.

Alternatively, the silk fibroin may be mixed with hydroxyapatite particles (see, e.g., PCT/US08/82487). As noted herein, the silk fibroin may be of recombinant origin, which provides for further modification of the silk such as the inclusion of a fusion polypeptide comprising a fibrous protein domain and a mineralization domain, which are used to form an organic-inorganic composite. These organic-inorganic composites can be constructed from the nano- to the macro-scale depending on the size of the fibrous protein fusion domain used (See, e.g., WO 2006/076711). See also U.S. patent application Ser. No. 12/192,588. Silk fibroin can also be chemically modified with active agents in the solution or on the surface of silk layer, for example through diazonium or carbodiimide coupling reactions, avidin-biodin interaction, or gene modification and the like, to alter the physical properties and functionalities of the silk protein. See, e.g., PCT/US09/64673; PCT/US10/41615; PCT/US10/42502; U.S. application Ser. No. 12/192,588.

The silk protein layers of the biophotobic sensor comprising active agents or biological materials may be suitable for long term storage and stabilization of the cells and/or active agents. Cells and/or active agents, when incorporated in the silk protein layers, can be stable (i.e., maintaining at least 50% of residual activity) for at least 30 days at room temperature (i.e., 22° C. to 25° C.) and body temperature (37° C.). Hence, temperature-sensitive active agents, such as some antibiotics or enzymes, can be stored in silk protein layers without refrigeration. Importantly, temperature-sensitive bioactive agents can be delivered (e.g., through injection) into the body in silk optical components and maintain activity for a longer period of time than previously imagined. See, e.g., PCT/US2010/026190.

A planar, deterministic, aperiodic, nanostructured pattern can be generated by arranging unit cells according to simple deterministic algorithms based or the alternation of 1D deterministic aperiodic inflation rules (e.g., Fibonacci rule) along both orthogonal directions. Alternatively, an aperiodic structure with broadband scattering characteristics can be engineered by using automated global optimization techniques. A unit cell can be a nano-pillar, a deposited particle, or a nano-hole of an arbitrary shape, e.g., circular cylindrical, elliptical, square, triangular, and the like, depending on specific applications needs.

Deterministic aperiodic arrays of the substrate can be designed based on number theory and L-systems. “Symbolic Dynamics and Its Applications,” edited by Williams, Am. Math. Soc. Publ. Providence, R.I. (2004); Macia, 69 Rep. Prog. Phys. 397-441 (2006); Boriskina et al., 16 Opt. Express 18813-826 (2008). Such geometries have recently been of interest for their unusual ability to redistribute electromagnetic radiation into complex colorimetric patterns (e.g. critical modes) yielding phase-sensitive structural color and “disorder-induced” localization. Boriskina et al., 2008; Lu et al., 10 Biomacromolecules 1032-42 (2009). These structures posses a large number of spatial frequencies, which can assist higher-order in-plane scattering processes and excite critical resonances in systems.

The aperiodic nanopatterned substrate can be designed in various ways, based on deterministic aperiodic, including but not limited to, Fibonacci, Thue-Morse and Rudin-Shapiro, Penrose lattices, prime number arrays, L-systems. In addition, novel aperiodic patterns can be generated by number-theoretic functions such as: co-prime function, Gaussian primes, Eisenstein's primes, Ulam's spirals, Galois fields, primitive roots, quadratic residues sequences, Riemann's zeta and L-functions.

In some embodiments, the aperiodic array of nanoparticles is based on the distribution of Gaussian Prime numbers (Williams, 2004). This structure possesses a singular Fourier spectrum that shows a high density of well-defined reflection planes (Bragg peaks) embedded in a diffused background of spatial frequencies which enhance phase-sensitive multiple scattering processes.

The deterministic, aperiodic nanopatterned substrate of the biophotonic sensor can be manufactured by nanofabrication techniques known to one skilled in the art, including but not limited to, electron-beam lithography, ion-beam milling, laser micromachining, and plasma etching. The deterministic, aperiodic nanopattern can be replicated over large areas by standard nano-imprint lithography. The substrate can include any materials suitable for nanofabrication process, including but not limited to, semiconductor, metal, low- and high-index dielectric platforms, glass, plastic, epoxy, or combinations thereof.

The silk material of the biophotonic sensor may be prepared by depositing an aqueous silk fibroin-containing solution on the aperiodic nanopatterned substrate and allowing the silk fibroin solution to dry into a thin layer. In this regard, the substrate coated with silk fibroin-based solution may be exposed in air for a period of time, such as 12 hours. Depositing the silk fibroin solution can be performed by, e.g., using a spin coating method, where the silk fibroin solution is spin coated onto the substrate to allow the fabrication of thin membranes of non-uniform in height.

In some embodiments, the smart slide can be prepared in following steps. Chromium nanoparticles (e.g., 200 nm diameter) arranged in aperiodic geometries was fabricated on a quartz substrate using electron-beam lithography. FIG. 1C shows a scanning electron microscope (SEM) image of the aperiodic lattice. The structure was then completed by adding a silk layer between the Cr-nanoparticles.

In some embodiments, the biophotonic sensor can be integrated into a liquid-sampling device such as microtiter plate; microarray slide, test tube, petri dish, and microfluidic channels for different biomedical device applications.

Another aspect of the invention relates to a method of detecting or analyzing an analyte, e.g., target. The method comprises the steps of obtaining a first spectral signature scattered from the surface of a biophotonic sensor, which comprises a substrate bearing deterministic, aperiodic nanostructured patterns, and a biological interface comprising a silk material situated between the nanostructured patterns on the substrate; exposing the biophotonic sensor to an analyte; obtaining a second spectral signature scattered from the surface of the biophotonic sensor; and determining the difference between the second and the first spectral signatures to detect or analyze the analyte.

The method may further comprise monitoring the change of spectral signature scattered from the surface of the biophotonic sensor in response to the change of the analyte. The spectral signatures can be obtained through the steps of illuminating the biophotonic sensor with a light source; detecting a spectral signature scattered from the biophotonic sensor when illuminated with the light source; optionally, converting the detected spectral signature to a corresponding color image; and optionally, performing a pattern recognition or analysis on the spectral signature to detect the presence or change of an analyte on the surface of the biophotonic sensor.

In some embodiments, the biophotonic sensor may be used to monitor the environment. The biophotonic sensor then can be simply placed in the surrounding environment and monitoring the change of spectral signature of the biophotonic sensor can monitor the presence or change of environmental features, where the analyte is the environmental features such as specific active agents or chemicals, changes in active agents or chemicals, changes in pH, moisture level, redox state, metals, light, stress levels, antigen binding, prions, among other targets.

In some embodiments, the analyte to be detected is present in a biological sample, including but not limited to, blood, plasma, serum, gastrointestinal secretions, homogenates of tissues or tumors, synovial fluid, feces, saliva, sputum, cyst fluid, amniotic fluid, cerebrospinal fluid, peritoneal fluid, lung lavage fluid, semen, lymphatic fluid, tears, and prostatitc fluid. The analyte to be detected or analyzed may be applied directly to the biophotonic sensor. Alternatively, the analyte may be contained in a medium. The medium can then be applied to the biophotonic sensor. The medium can be aqueous solutions, liquids, or any solvents that are convenient for the user. In some embodiments, the medium can be a silk fibroin solution or gel. In some embodiments, the analyte or the medium containing the analyte may be further dried into thin film or monolayer.

In some embodiments, the method of detection or analysis of the analyte is monitored by frequency shift of the light scattered from the surface of the biophotonic sensor in response to the local refractive index variations of the biophotonic sensor.

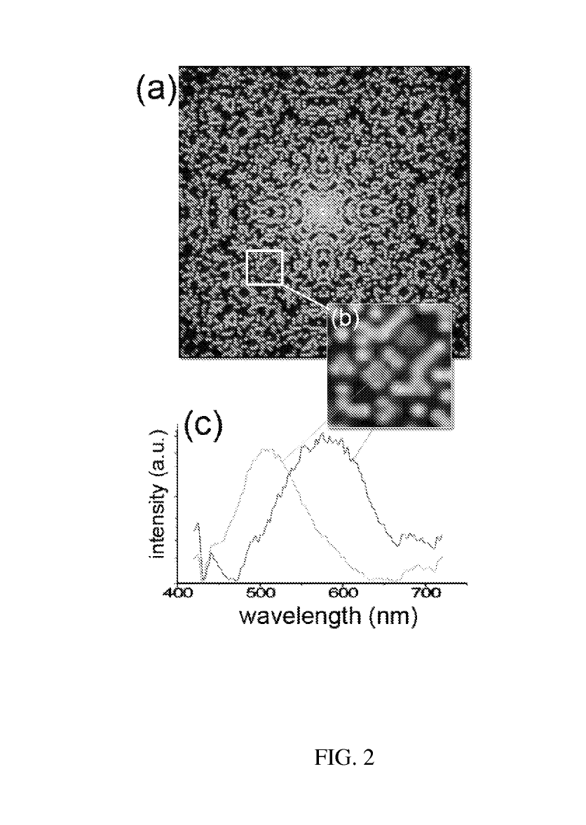

In some embodiments, detecting the presence of an analyte on the nanopatterned smart-slide may use a conventional scattering microscopy in the visible spectral range. For example, the smart-slide may be placed under a dark-field microscope, the white light from the condenser was then scattered and spectrally rearranged into a structural color pattern (referred to as “nanoquilt”) that can then be captured at the image plane of the microscope. Unlike periodic grating structures, the scattering response of aperiodic nanopatterned surfaces shows complex and deterministic colorimetric fingerprints (FIG. 2), which shows the dark-field image acquired from a Gaussian-Prime Lattice (GPL) (Williams, 2004) under white light illumination.

The dark-field image can be acquired with a multispectral CCD camera (e.g., Nuance™, CRi, Woburn, Mass.) which covers the range from 450 nm to 720 nm with a resolution of 2 nm, providing a map of the spectral response of the aperiodic lattice.

The nanoscale redistribution of color can be determined by structure-induced complex scattering and establishes the multi-frequency spectral baseline for colorimetric detection. The scattering process is information-rich since each individual spectral component is organized according to different spatial patterns on the surface of the aperiodic array. For example, FIG. 2B and FIG. 2C show details of the spectral distribution in the same GPL and the spectral response corresponding to a ˜600×600 nm area of the specific portion of the aperiodic lattice.

The aperiodic multiple scattering regime of the biophotonic sensor can achieve sensitivities that rival plasmonic or photonic crystal-based sensors due to the onset of disordered induced light localization effects. As the surface topography is perturbed, the scattering properties of the lattice change and, accordingly, the distribution of the different spectral components on the surface of the lattice would change. The overall scattering response is consequently altered and results in an overt structural color change caused by this spectral pattern redistribution. For example, depositing an additional silk layer on the silk biophotonic slide can further illustrate this light localization effects.

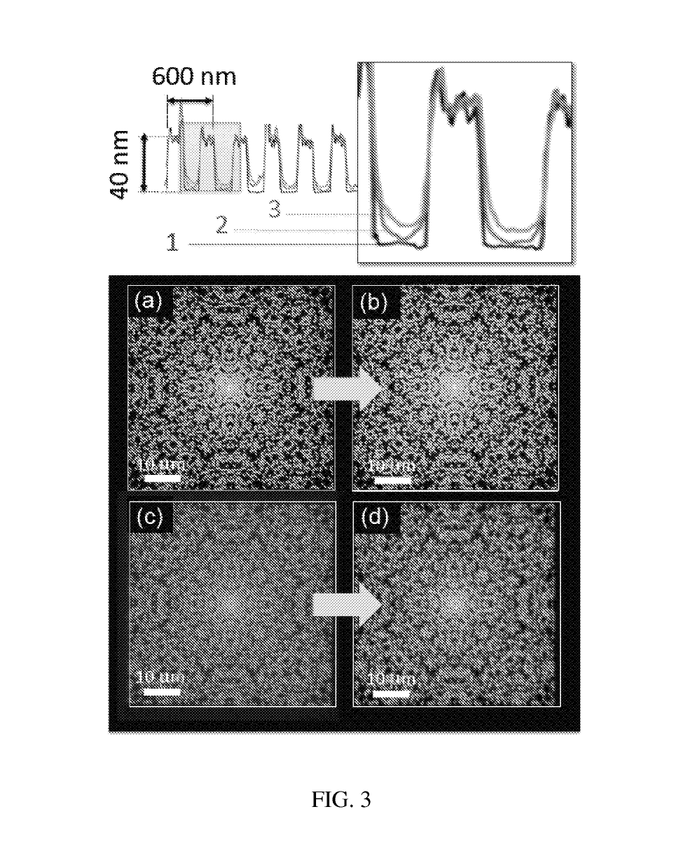

In some embodiments, a thin layer of silk was deposited on the silk smart-slide device by spin-coating a dilute solution of the protein onto the device. This process causes an increase in the protein thickness by 30 Å, equivalent to a protein monolayer. The surface topography was quantified by measuring the surfaces before and after spin-coating by atomic force microscopy (AFM) (FIG. 3). This additional layer of silk, like the layer of silk already included on the smart-slide surface, is located between the nanostructures on the substrate of the smart-slide (e.g., between chromium nanoparticles).

The smart-slide was then placed under the microscope maintaining identical illumination conditions. An overall color change was observed in comparison to the baseline image, underscoring the effectiveness of the approach to respond to protein monolayer variations in real-time, label-free fashion. FIG. 3A and FIG. 3B show the change in color detected originally without post-process, and FIG. 3C to FIG. 3D show the corresponding color change by post-processing the image to display the scattering responses centered at 520 nm and 590 nm. In both cases (with and without post-process), the colorimetric shift due to the presence of a silk monolayer is apparent. The detection of such an ultra-thin protein monolayer is label-free.

Additionally, the multiple, deterministic components encoded in the nanoquilt (angular spectra, scattering intensity, correlation patterns) can be used as a source of information to define a multiparametric sensing platform for real-time nanoscale detection of biological materials in the visible spectral range.

Moreover, the ability of silk films or silk layers as a storage matrix for labile biochemical dopants (Lu et al., 2009) allows for the incorporation of biologically active substrates on a smart-slide assembly to offer assays with increased readout ease and sensitivity. For example, the structural color change illustrated in the transitions of FIG. 3 (3A to 3B and 3C to 3D) corresponds to an estimated change in surface protein concentration of less than one attomole (Adato et al., 2009). By leveraging the engineered multispectral scattering responses of aperiodic surfaces, the use of deterministic aperiodic lattices in combination with functionalized silks can yield nanoscale sensitivity to local refractive index variations within a simple, cost-effective approach for microfluidics structures, bio-assays, and label-free detection of biological materials and dynamics.

Another aspect of the invention relates to an apparatus comprising a biophotonic slide; a light source that illuminates the biophotonic slide; a detector that receives spectral signatures scattered from the biophotonic slide when illuminated with the light source, and optionally, converts the received spectral signatures to a corresponding color image; and optionally, an image processing circuitry that recognizes or analyzes the spectral signatures to detect the presence or change of an analyte on the surface of the biophotonic slide. The biophotonic slide comprises a substrate bearing deterministic, aperiodic nanostructured patterns, and a biological interface comprising a silk fibroin monolayer situated between the nanostructured patterns on the substrate.

In some embodiments, the apparatus comprises a biophotonic slide having the two-dimensional nanoscale deterministic aperiodic structures, a white light source, a conventional dark-field micro-spectroscopy that receives the structural color patterns. Such apparatus is combined with spatial correlation imaging analysis (Petersen et al., 65 Biophys. J. 1135-46 (1993)), and used as a label-free biosensing device to detect, in the visible spectral range, protein layers with thickness of a few tens of Angstroms.

Accordingly, biophotonic sensors described herein provide useful tools in a wide variety of applications, including diagnostic assays and environmental monitoring. The invention therefore includes related methods for analyzing a sample. In contemplated methods, a biophotonic sensor unit is provided, which comprises a patterned surface having aperiodic nanostructured protrusions and a silk material deposited between the protrusions of the patterned surface, as described in more detail herein. As described herein, each particular such surface produces a deterministic (e.g., predictable) light scattering pattern when illuminated. This “signature” pattern functions as a reference, to which test signals can be compared. The biophotonic sensor unit is contacted with a sample to be analyzed. Once molecular interactions take place, the biophotonic sensor unit is illuminated with a suitable light source to now generate a test signal. At any of various steps in the methods, materials not captured on the solid support are optionally separated from the support (and thus from any support-bound materials).

Where there is productive binding (e.g., molecular interaction) between a component of the sensor (e.g., silk-based material) and an analyte present in the sample, the resulting light scattering pattern now shifts, with respect to the reference signature. Thus, change in the spectral signature is indicative of molecular change at the site of illumination on the sensor. Without being bound to a particular theory, it is believed that such shift is at least in part brought about by silk's unique optical properties that contribute to its signal-enhancing effects.

The analysis of the resulting signals (e.g., light scattering patterns and changes thereof) is based on at least one optical parameter, such as a shift in the location of a peak, and the data can be compared to a reference (obtained without analyte or any other suitable control), wherein the difference between the data provides analytical information on the test sample. In some embodiments, measured change in light scattering pattern provides analytical information which indicates that a particular analyte is present or absent in the sample. In some embodiments, measured changes in light scattering pattern provides analytical information which indicates that a particular analyte is present in the sample in an increased or decreased level relative to a control sample. In some embodiments, measured changes in light scattering pattern provides analytical information which indicates that there is structural or conformational change in an analyte.

The contemplated platform and methods can be readily adopted for a high-throughput, multiplex system, which allows parallel processing of two or more samples, as well as two or more analyses of each sample. A plurality of aperiodic nanostructured sensor units comprising a silk material can be fabricated upon a chip (e.g., micro-chip) for a wide variety of multiplex applications. Typically, the plurality of biophotonic sensor units is arranged in a suitable array (such as micro-array) on the chip. One of ordinary skill in the art will readily appreciate suitable applications and fabrication methods thereof, according to the description provided herein, in view of the state of the art.

In some embodiments, a chip comprises a plurality of sensor units, each of which is designed to provide predetermined analytical information. For instance, each sensor unit may include a silk material embedded with an indicator for a particular clinical condition, such as infections, immunological disorders, cancers, and so on. To illustrate, a chip may comprise a plurality of sensor units, each of which is designed to be reactive to a variety of infectious agents (e.g., pathogens or microbes). A single biological sample collected from a subject suspected to have an infection may be analyzed on such a chip simultaneously. Shift in light scattering patterns as measured by one or more optical parameters can provide analytical information as to which infectious agent(s) may be detected in the sample. To provide another example, a chip may be constructed to include an array of agents that bind to biological molecules (proteins, hormones, cytokines, etc.) known to be associated with diseases and disorders. A biological sample collected from a subject to be tested is contacted with the chip, and the pattern of optical readout obtained, either singly or collectively, may provide analytical information, for purposes of diagnosis or monitoring the progress of a disease/disorder of effects of treatment.

As discussed, in some embodiments, suitable optical parameters used to provide analytical information include frequency, amplitude, correlation, autocorrelation, two-dimensional autocorrelation, normalized correction, and any combination thereof. Raw data which may be collected from the contemplated assays include, without limitation, a location of a peak in the spectral signature; a color change in the signal; a variance of secondary data produced by applying a correlation function to the signal; a variance of secondary data produced by applying an autocorrelation function to the signal; a variance of secondary data produced by applying a two-dimensional, normalized autocorrelation function to the signal, or any combination thereof.

The present invention is not limited to the particular methodology, protocols, and reagents, etc., described herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities of ingredients or reaction conditions used herein should be understood as modified in all instances by the term “about.”

All patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Unless defined otherwise, all technical and scientific terms used herein have the same meaning as those commonly understood to one of ordinary skill in the art to which this invention pertains. Although any known methods, devices, and materials may be used in the practice or testing of the invention, the methods, devices, and materials in this regard are described herein.

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

### EXAMPLES

### Example 1

### Gratings Fabrication

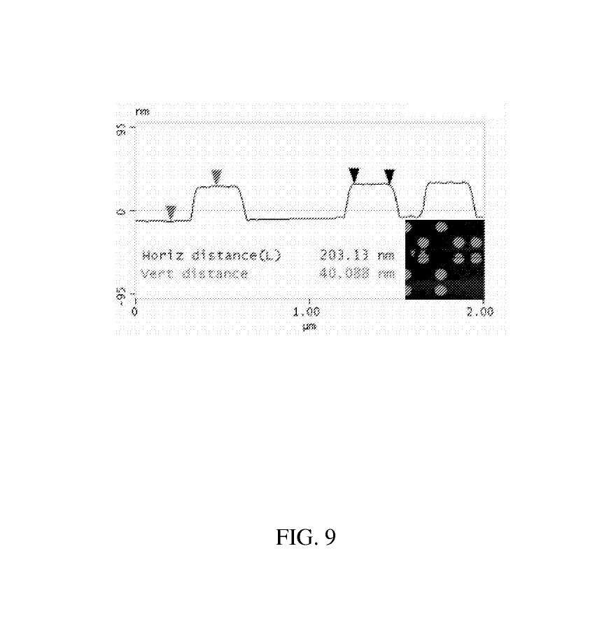

Periodic and aperiodic nanoparticle arrays were fabricated using Electron Beam Lithography (EBL) on quartz substrates. The fabrication process flow is as follows: A 180 nm of PMMA 950 (Poly Methyl Meth Acrylate) was spin-coated on top of quartz substrates, and the substrates were soft-baked on a hot plate at 180° C. for 90 sec. A 10 nm-thin continuous gold film was then sputtered on top of the resist to facilitate electron conduction for EBL writing. The nanopatterns were defined using a Zeiss SUPRA™ 40 VP SEM (Zeiss, Oberkochen, Germany) equipped with Raith beam blanker (Raith, Dortmund, Germany) and Nanometer Pattern Generation System (NPGS) for nanopatterning. The resist was subsequently developed and a 40 nm Cr thin film was deposited by e-beam evaporation. After lifting-off using acetone solution, the arrays with Cr nanoparticles were obtained. The resulting features of nanopatterned arrays are shown in FIG. 9 and are approximately 40 nm in height with radii of 100 nm, as measured by atomic force microscopy (AFM).

### Example 2

### Preparation of Silk Material

Production of silk fibroin solutions has been described previously. Perry et al., 2008; McCarthy et al., 54 J. Biomed. Mats. Res. 139 (2001). Briefly, sericin, a water-soluble glycoprotein bound to raw fibroin filaments, was removed from the silk strands by boiling B. mori cocoons in a 0.02 M aqueous solution of Na2CO3 for 30-60 min. Thereafter, the remaining silk fibroin bundle was rinsed thoroughly in purified water to extract the glue-like sericin proteins and allowed to dry overnight. The dry fibroin bundle was then dissolved in a 9.3 M aqueous solution of LiBr at room temperature or heated at 60° C., yielding a 20 wt % solution. The LiBr salt was then extracted from the solution over the course of 48 hrs or more, through a water-based dialysis process using Slide-A-Lyzer® 3.5K MWCO dialysis cassettes (Pierce, Rockford, Ill.). Any remaining particulates were removed through centrifugation and syringe-based micro-filtration (5 μm pore size, Millipore Inc., Bedford, Mass.). This process can yield 8%-10% (w/v) silk fibroin solution with minimal contaminants and reduced scattering for optical applications.

The silk solution may be diluted to a lower concentration, or, may be concentrated, for example, to about 30% (w/v), if desired. See, e.g., WO 2005/012606. Briefly, the silk fibroin solution with a lower concentration may be dialyzed against a hygroscopic polymer, such as PEG, amylose or sericin, for a time period sufficient to result in a desired concentration. Additionally, silk fibroin solution can be combined with one or more biocompatible polymers such as polyethylene oxide, polyethylene glycol, collagen, fibronectin, keratin, polyaspartic acid, polylysin, alginate, chitosan, chitin, hyaluronic acid, and the like; or one or more active agents, such as cells, enzymes, proteins, nucleic acids, antibodies and the like, as described herein. See, e.g., WO 04/062697 and WO 05/012606. Silk fibroin can also be chemically modified with active agents in the solution, for example through diazonium or carbodiimide coupling reactions, avidin-biodin interaction, or gene modification and the like, to alter the physical properties and functionalities of the silk protein. See, e.g., PCT/US09/64673; PCT/US10/41615; PCT/US10/42502; U.S. application Ser. No. 12/192,588.

After preparation of the silk fibroin solution, the solutions were then poured onto nanopatterned quartz substrates and allowed to air dry in a laminar flow hood. The solutions were then left to dry for 24 or 48 h until all the solvent had evaporated to give solid fibroin protein silk films or conformational layers. Adjusting the concentration and/or the volume of the silk fibroin solution cast on the substrate can result in silk films or conformational layers from 2 nm to 1 mm thick. Alternatively, the silk fibroin solution can be spin-coated on a substrate using various concentrations and spin speeds to produce films or layers from 1 nm to 100 μm. These silk fibroin films have excellent surface quality and optical transparency.

Additionally, the silk film or layers may be activated, for example, by polyethylene glycol (see, e.g., PCT/US09/64673) and/or loaded with an active agent and cultured with organisms, in uniform or gradient fashion. See, e.g., WO 2004/0000915; WO 2005/123114; U.S. Patent Application Pub. No. 2007/0212730. Other additives, such as polyethylene glycol, PEO, or glycerol, may also be loaded in the silk layers to alter features of the silk layers, such as morphology, stability, flexibility, and the like. See, e.g., PCT/US09/060,135. More functionality may be conferred to the silk layers, for example, through enzymatically polymerization a conducting polymer can be generated between silk layers and the substrate supporting the silk layers, making an electroactive silk matrix, and providing potentials of electro-optical devices. See, e.g., WO 2008/140562.

### Example 3

### Dark-Field Scattering Setup and Image Acquisition

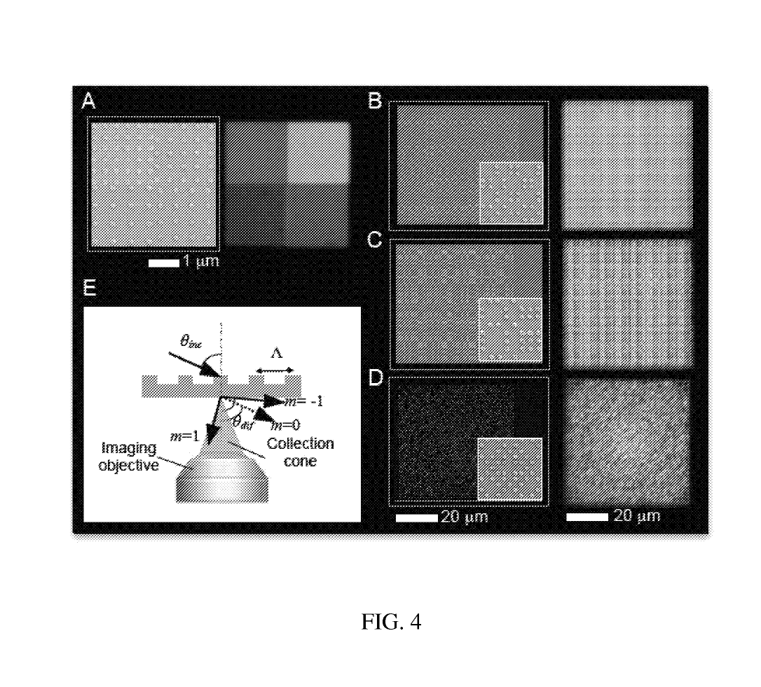

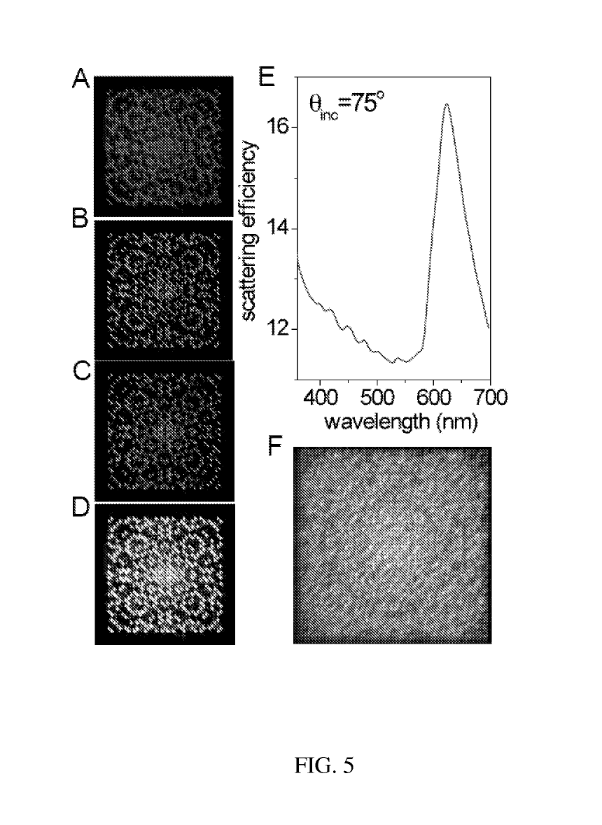

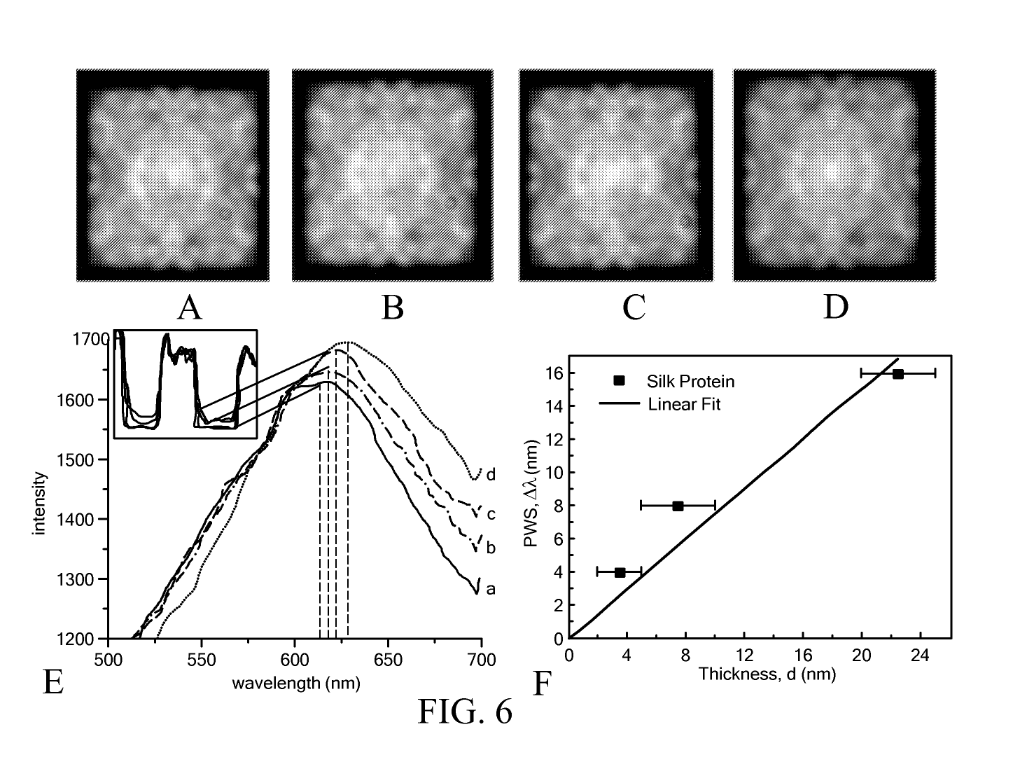

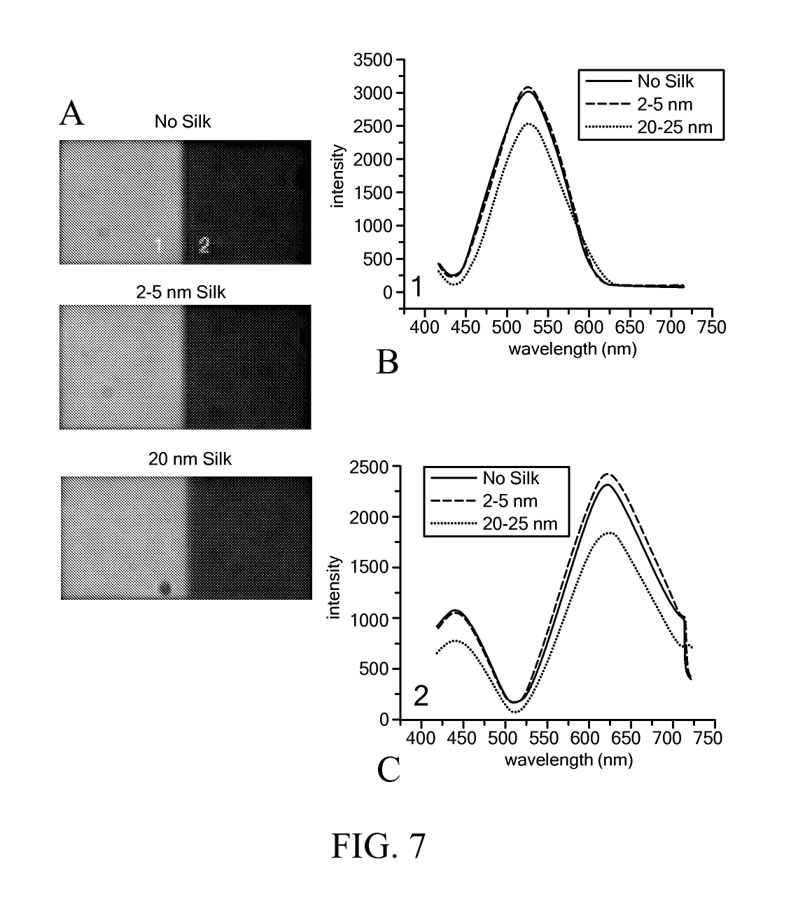

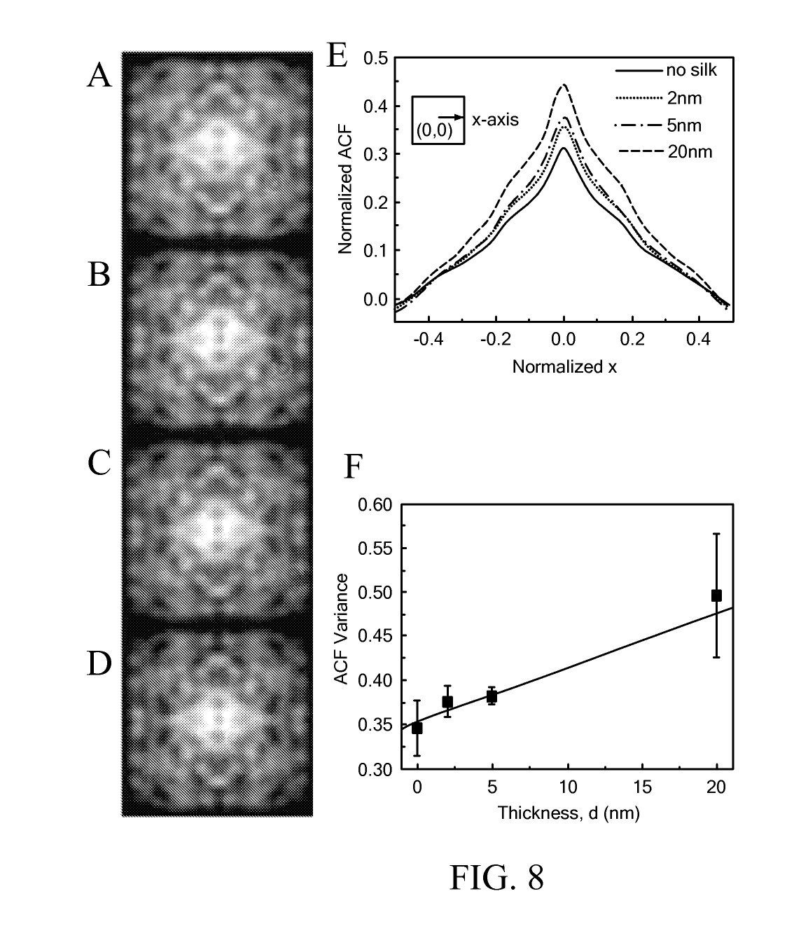

FIGS. 4B-4D and FIG. 5F were collected in dark-field under white light illumination using a backscattering microscope setup with a 50× objective (N.A.=0.5) and a CCD digital camera (Media Cybernetics Evolution VF). The incident angle of the illumination was approximately 15° to the array plane, as shown in the FIG. 4E. Dark-field images and wavelength spectra were also measured in a transmission configuration using a dark-field condenser with N.A. 0.8-0.92. The transmitted light was collected with a 10× objective through a 1 mm iris (decreasing the N.A. ˜0.1) and spectral images were obtained using a hyperspectreal CCD (CRi Nuance FX) camera coupled to an Olympus IX71 microscope (FIG. 6, FIG. 7, FIG. 8).

### Example 4

### Colorimetric Fingerprints of Periodic Gratings

Colorimetric response of periodic arrays of Cr nanoparticles deposited on quartz substrates were briefly reviewed.

Two-dimensional periodic gratings of 100 nm-radius and 40 nm-tall Cr nanodisks (shown in FIG. 9) of varying lattice constants were fabricated on quartz substrates using EBL (See, e.g., procedures in Example 1). The scanning electron micrographs of representative grating structures are shown in FIG. 4A. The arrays were illuminated by an incoherent white light source at a grazing angle incidence (θinc=75 degrees) to the array surface using the dark-field scattering setup sketched in FIG. 4E, and a microscope objective lens was used to collect the scattered radiation normal to the array plane (See, e.g., experimental setup in Example 3). Increasing the grating period resulted in a progressive red-shift of the colorimetric responses (scattered wavelengths), as shown in FIG. 4A. These colorimetric responses of periodic gratings can adequately be described by the classical Bragg formula:

$$λ = \frac{Λ}{m} ( {n}_{1} sin {θ}_{inc} \pm {n}_{2} sin {θ}_{dif} ) , m = 0 , \pm 1 , \pm 2 … , \qquad [ 1 ]$$

where Λ is the lattice constant, λ is the wavelengths of the incident light, θinc and θdif are the incident and the diffracted angles (measured with respect to the normal to the grating surface), m is the order of diffraction and n1 and n2 are the refractive indices of the grating and of the surrounding medium, respectively. The calculated colorimetric responses corresponding to different lattice constants (500 nm-800 nm) varied as a function of the diffraction angle. In addition, the spectral response was determined by the finite angular collection efficiency of the imaging lens as depicted in FIG. 4E by the blue area. The distinctive wavelength shift of the radiation scattered by periodic gratings perturbed by the presence of specific analytes has been traditionally utilized as a transduction signal in colorimetric optical sensing. Cunningham et al., 2002; Lin et al., 2002; Lee & Fauchet, 2007; Xiao & Mortensen, 2006; Morhard et al., 1997.

### Example 5

### Colorimetric Fingerprints of Aperiodic Gratings

The deterministic aperiodic nanopatterned photonic devices, which lack transla-tional invariance symmetry (they are nonperiodic), however, have specific optical properties and were generated by simple constructive rules (Dal Negro et al., 10 J. Opt. A Pure Appl. Opt. 064013 (2008); Gopinath et al., 8 Nano. Lett. 2423-31 (2008)). Such structures, which can be fabricated using conventional lithographic techniques, are an intermediate regime between periodic and disordered systems, yet are engineered according to mathematical rules amenable to predictive theories. In contrast to traditional photonic gratings or photonic crystals sensors (which efficiently trap light in small-volume defect states), aperiodic photobic sensors sustain distinctive resonances localized over larger surface areas. In particular, nanoscale aperiodic structures possess a dense spectrum of highly complex structural resonances (referred as “critical modes”), which result in efficient photon trapping and surface interactions through higher-order multiple scattering processes thereby enhancing the sensitivity to refractive index changes (Boriskina & Dal Negro, 16 Opt. Express 12511-522 (2008); Boriskina et al., 16 Opt. Express 18813-826 (2008)). The complex spatial patterns of critical modes in these structures can engineer structural color sensing with spatially localized patterns at multiple wavelengths (referred to as “colorimetric fingerprints”).

Unlike periodic grating structures, the scattering response of aperiodic nanopatterned surfaces featured highly complex colorimetric fingerprints, as demonstrated in FIGS. 4B-4D. Three main types of deterministic aperiodic structures with varying degree of structural disorder were used. Specifically, Thue-Morse (Dal Negro et al., 2008; Gopinath et al., 2008; Boriskina & Dal Negro, 2008; Boriskina et al., 2008; Moretti & Mocella, 15 Opt. Express 15314-323 (2007)) (FIG. 4B), Rudin-Shapiro (Dal Negro et al., 2008; Gopinath et al., 2008; Boriskina & Dal Negro, 2008; Boriskina et al., 2008; Dulea et al., 45 Phys. Rev. B 105-14 (1992)) (FIG. 4C), and Gaussian prime (Schroeder, “Number theory in science and communication,” Springer-Verlag, New York (1985)) (FIG. 4D) arrays of Cr nano-particles with minimum center-to-center separation of 300 nm and 400 nm were used in the nanostructured aperiodic patterns.

The spatial complexity of these aperiodic structures can be described by the spectral character of their spatial Fourier spectra, which in contrast to simple periodic structures, densely fills the reciprocal space with distinctive fractal properties (Schroeder, 1985; Janot, “Quasicrystals: a Primer,” Oxford University Press, New York (1997); Ryu et al., 46 Phys. Rev. B 5162-68 (1992); Macia, 60 Phys. Rev. B 10032-036 (1999)). In particular, Gaussian prime lattices feature nonperiodic Fourier spectra with well-defined reciprocal lattice vectors (Bragg-peaks) (Schroeder, 1985), while the more complex Thue-Morse and Rudin-Shapiro structures display singular continuous and absolutely continuous Fourier spectra (Dal Negro et al., 2008; Gopinath et al., 2008; Boriskina & Dal Negro, 2008; Boriskina et al., 2008; Moretti & Mocella, 2007; Dulea et al., 1992), respectively. All these aperiodic surfaces possess a large number of spatial frequencies, which can assist higher-order in-plane scattering processes and excite the critical resonances of the systems.

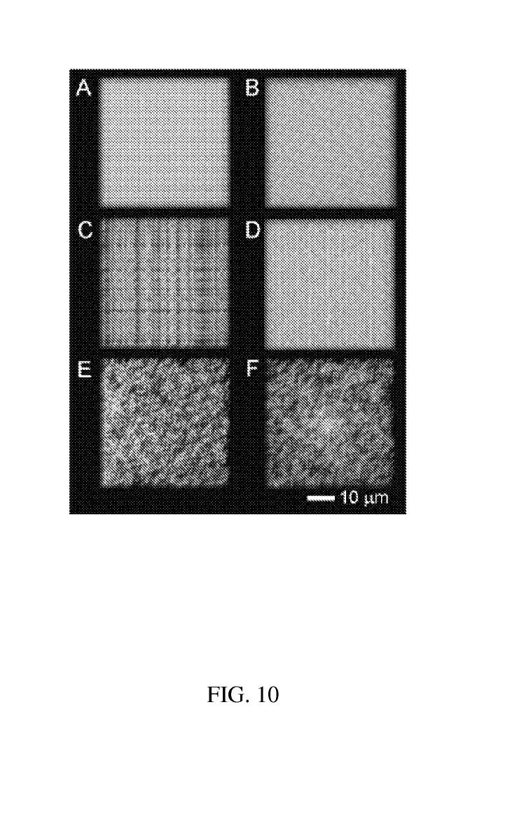

When these aperiodic structures were illuminated by a white light source, they produced highly organized structural color patterns as shown in FIG. 4. (Additional patterns obtained from different deterministic aperiodic arrays are shown in FIG. 10).

The origin of the experimentally observed colorimetric fingerprints can be explained using rigorous multiple scattering theory on model structures in three spatial dimensions.

Aperiodic systems typically possess a dense spectrum of critical modes, featuring unique fractal scaling and spatial localization character with traits intermediate between Anderson and Bloch modes (Boriskina et al., 2008; Janot, 1997; Ryu et al., 1992). When these modes are excited, photons can be efficiently trapped on the surface of aperiodic systems enabling enhanced surface interactions in comparison to what can be achieved using traditional optical modes. Boriskina & Dal Negro, 2008.

The origin of the experimentally observed colorimetric fingerprints of aperiodic arrays of subwavelength particles was analyzed by performing three dimensional light-scattering simulations on model structures consisting of Cr nanospheres arranged in periodic and aperiodic two-dimensional lattices. These structures were illuminated by a plane wave incident at a grazing angle (θinc=75 degrees—consistent with the experimental conditions) to the array plane. The far-field scattering characteristics and intensity distribution in the array plane of the scattered electric field were calculated using the rigorous GMT approach. Mackowski, 1994; Palik, “Handbook of optical constants of solids,” Academic Press, London (1998).

The formation of this distinctive multispectral response may be illustrated in FIGS. 5A-5D, e.g., for the case of Gaussian prime arrays. The calculated scattering spectrum of the Gaussian prime array (FIG. 5E) illuminated by a plane wave revealed variations of the array scattering efficiency (the ratio of the scattering cross section to the total volume of the particles, Gopinath et al., 2008) as a function of the wavelength. Furthermore, the calculated scattered intensity pattern in the plane of the array featured different spatial distributions of critical modes corresponding to different wavelengths (FIGS. 5A-5C). When the colorimetric patterns of the Red-Green-Blue (RGB) principal chromatic components (wavelengths 630 nm, 520 nm, and 470 nm) were mixed together in the array plane (FIG. 5D), a complex structural color pattern (colorimetric fingerprint) was formed in qualitative agreement with the experimentally measured data, shown in FIG. 5F, collected under white light illumination. The formation of this complex pattern illustrates the possibility of spatial localization of individual frequency components on the nanostructured surface. Due to the aperiodicity of the structure, the incoming radiation field intensity was redistributed, at each given frequency, into a multitude of spatial directions. The superposition of the scattered fields associated to the modes of individual spectral components produced spatial colorimetric patterns determined by the surface geometry—a multispectral fingerprint.

The formation of multispectral fingerprints with structural color localization in deterministic aperiodic nanostructures provides a mechanism to engineer optical devices where both the spectral and the spatial information encoded in the scattered fields can be retrieved for sensitive optical detection beyond Bragg scattering.

### Example 6

### Sensitivity of Aperiodic Structures to Protein Monolayers

The complex, information-rich colorimetric fingerprints (e.g., “signature”) of aperiodic nanopatterned surfaces can be used as transduction signals to engineer highly sensitive label-free scattering sensors.

The colorimetric fingerprints of aperiodic nanopatterned structures in response to the deposition of protein monolayers (e.g., silk fibroin) on the nanopatterned aperiodic substrate (Omenetto & Kaplan, 2 Nat. Photonics 641-43 (2008)) were experimentally examined. Silk was used to form monolayers on photonic lattices as the biointerface for the biophotonic sensor because of its ability to make highly uniform layers of controllable thicknesses ranging from 2 nm to several microns.

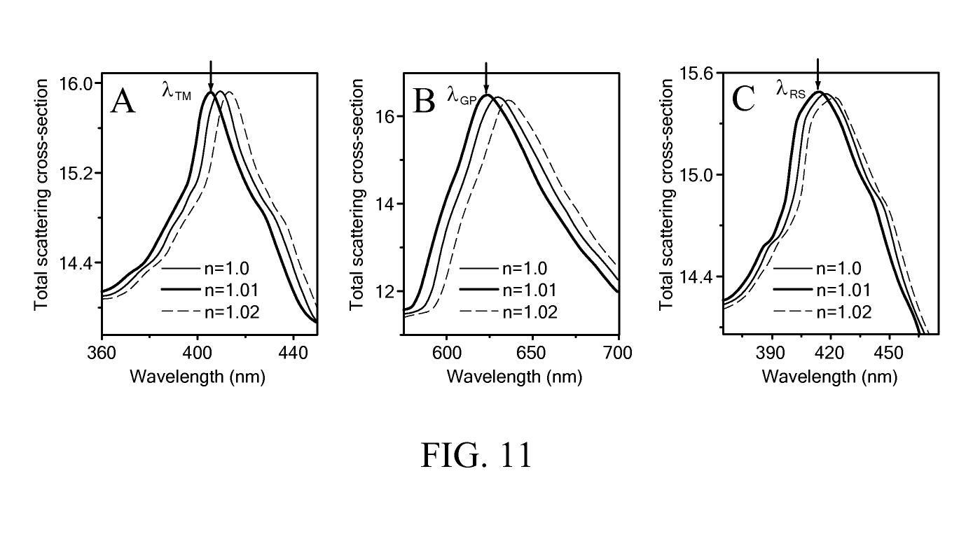

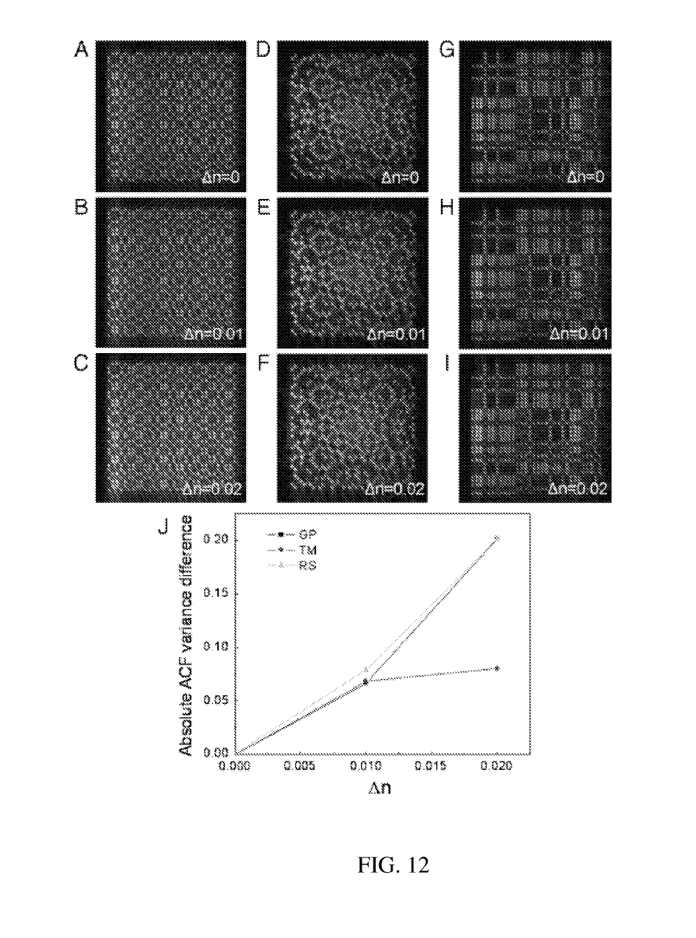

The sensitivities of colorimetric fingerprints formed on substrate with various aperiodic nanopatterns to the variations in the ambient refractive index were compared by using the GMT simulations (see FIGS. 11 and 12). Simulation results revealed high sensitivity of the fingerprints of Gaussian prime and Rudin-Shapiro arrays to environmental changes, consistent with the general principles of linear response theory applied to rough surface scattering.

For example, one analysis was on the Gaussian prime array, which strongly scatters radiation in the visible spectral range (see, e.g., FIG. 11). Distinctive changes induced by the presence of the protein layers with thicknesses varying in few monolayer increments in both colorimetric fingerprint and scattering spectrum of the Gaussian prime array were experimentally demonstrated in FIG. 6. The shift of the scattering spectrum measured in the presence of protein layers (FIG. 6E) was quantified by estimating the slope of the Peak Wavelength Shift (PWS) plotted versus the thickness of the protein layer.

A linear fit of the experimental data shown in FIG. 6F demonstrates device sensitivity of approximately 1.5 nm per protein monolayer (˜20 Angstroms). This value was comparable to that reported for photonic crystal structures and surface plasmon biosensors (Lee & Fauchet, 2007; Adato et al., 2009; Willets & Van Duyne, 58 Annu. Rev. Phys. Chem. 267-97 (2007)). The smallest detection volume of silk protein was estimated as A(t)(D/M), where A is the total surface area of the Gaussian prime nanopatterned array (48.2×48.2 μm2), t is the film thickness (2 nm), D is the density of the protein (1.4 g/cm3) (Warwicker, 7 Acta. Crystallogr. 565-71 (1954)) and M is the molecular mass of the protein (375 kDa) (Sashina et al., 79 Russ. J. Appl. Chem+ 869-76 (2006)). About 17 atto-mole of protein molecules was estimated to contribute to the distinctive shift of the spectral peak and the colorimetric pattern change. This detection limit can be improved by minimizing the size of the nanopatterned surface.

Typically, when using periodic gratings with Bragg scattering efficiency optimized in the same spectral region as the Gaussian prime arrays, no protein detection may be observed in the 2-5 nm thickness range. As shown in FIG. 7, periodic grating sensors excited in the same experimental geometry did not reveal any spectral shift in response to the deposition of 2-5 nm thick protein layers on the surface of the samples. A small colorimetric response was detected when 20 nm thick layers were deposited on the periodic gratings, corresponding to a small shift in the peak of their scattering spectra (FIG. 7C). Enhanced sensitivities using periodic gratings may only be achieved by measuring enhanced backscattering intensities or by introducing structural defects to form photonic crystal cavities at specific wavelengths (Cunningham et al., 2002; Lee & Fauchet, 2007).

On the other hand, aperiodic surfaces with engineered colorimetric fingerprints can detect protein monolayers by observing, with conventional dark-field microscopy, distinctive structural modifications of the spatial distribution of the individual spectral components of the scattered radiation field, as demonstrated in FIGS. 8A-8D in the case of silk nanolayers. This detection mechanism utilized the fingerprinting structural resonances perturbed by the presence of nanoscale protein layers. Therefore, in the case of aperiodic structures, both the peak wavelength shift of the scattered radiation as well as the spatial structure of their distinctive colorimetric fingerprints can be utilized in order to detect the presence of nanoscale protein layers.

The spatial modifications of the structural color fingerprints of aperiodic surfaces can be readily quantified by image autocorrelation analysis performed on the radiation intensity scattered by the bare surface and by the silk coated surface (Wiseman & Petersen, 76 Biophys. J. 963-77 (1999); Bliznyuk et al., 167 Macromolecular Symposia 89-100 (2001)). The two-dimensional image autocorrelation function (ACF) of a colorimetric fingerprint G(ξ, η) was obtained from the scattering data by proper normalization as:

$$g ( ξ , η ) = 〈 δ s ( x , y ) δ s ( x + ξ , y + η ) 〉 = \frac{G ( ξ , η )}{{〈 s ( x , y ) 〉}^{2}} - 1 , \qquad [ 2 ]$$

where s(x,y) is the fluctuating spatial signal and the angle brackets < > indicate averaging (integration) over the spatial domain. The normalized ACF of the structural color fingerprints of the aperiodic surfaces obtained from the bare and the silk coated surfaces was then calculated, and the spatial modification of the fingerprints was quantified by comparing their variances, which can be readily obtained by evaluating the normalization of the ACF in the limit of zero lateral displacements (Wiseman & Petersen, 1999; Bliznyuk et al., 2001):

$$var δ s ( x , y ) = {lim}_{ξ \to 0} {lim}_{η \to 0} g ( ξ , η ) = g ( 0 , 0 ) . \qquad [ 3 ]$$

This analysis, which was performed on the principal RGB spectral components of the scattered radiation, can unveil significant structural color modifications associated to the refractive index perturbation of aperiodic systems.

This effect was demonstrated by performing the autocorrelation analysis at the peak wavelength (622 nm) of the scattered spectrum of a Gaussian prime surface, shown in FIGS. 8E and 8E In FIG. 8E, the one-dimensional ACF profiles extracted from the two-dimensional intensity autocorrelation functions for different thicknesses of the protein layer were plotted. The initial decay in the ACF reflected local short-range correlations in the aperiodic structure, while long-range correlations in the intensity pattern resulted periodic oscillations in the ACF (Bliznyuk et al., 2001). The change in the structural color patterns (at any given wavelength of interest) induced by the presence of thin protein layers can be made quantitative by computing the variance of the scattered field intensity fluctuations. The experimental results in FIG. 8 indicate a substantial change in both the normalized ACF variance of perturbed colorimetric fingerprints and its complex spatial structure encoded in the ACF oscillatory behavior (which reflects the long-range oscillations). These results demonstrated the capability of the aperiodic nanopatterned photonic sensor to detect protein monolayers, in the visible spectral range, using conventional dark-field microscopy.

In summary, critical mode patterns were used as surface sensing elements for the biophotonic sensor with sensitivity to protein monolayer morphological changes. By using frequency-resolved spatial analysis of colorimetric fingerprints in nanopatterned surfaces with deterministic aperiodic order, the sensor demonstrated the ability to discriminate spectrally and spatially, in the visible spectral range, nanoscale surface variations down to the single protein monolayer (20 Angstrom). The sensor was intrinsically more sensitive to local refractive index modifications compared to traditional ones (Boriskina & Dal Negro, 2008) due to the enhancement of small phase variations, which is typical in the multiple light-scattering regime (Tsang et al., 2000; Maradudin, 2007). The sensitivity levels are comparable to photonic crystals and surface plasmon biosensors. The origin of structural color localization in aperiodic arrays of Chromium (Cr) nanoparticles on quartz substrates were, explained by combining dark-field scattering micro-spectroscopy and rigorous calculations based on the Generalized Mie Theory (GMT) (Mackowski, 11 J. Opt. Soc. Am. A 2851-61 (1994)).

Furthermore, the complex spatial patterns of critical modes in nanostructured aperiodic surfaces can be analyzed by image correlation analysis in the visible spectral range, providing a transduction mechanism with large dynamic range, sensitivity and multiplexing capabilities where the information encoded in both spectral and spatial distributions of structural colors can be simultaneously utilized. The detection scheme used the conventional dark-field microscopy and standard image correlation analysis, and did not require dedicated setups. These results, which can be consistently obtained using various other types of aperiodic nanopatterns, indicate the aperiodic nanopatterned sensor can be used as inexpensive, real-time sensing of analytes in the visible spectral range using conventional microscopy techniques.

### Example 7

### Theory and Analysis

Generalized multi-particle Mie theory. The rigorous GMT approach (also called the rigorous theory of multipole expansions; Mackowski, 11 J. Opt. Soc. Am. A 2851-61 (1994); Quinten & Kreibig, 32 Appl. Opt. 6173-82 (1993); Xu, 34 Appl. Opt. 4573-88 (1995); Kreibig & Vollme, “Optical Properties of Metal Clusters,” Springer-Verlag, Berlin (1995); Bohren & Huffman, “Absorption and Scattering of Light by Small Particles,” John-Wiley & Sons, New York (1998)) was used to provide an interpretation of the experimental data.

Although the application domain of GMT may be restricted to spherical scatterers, it can yield an analytical solution of the scattering problem and results in highly efficient algorithms. In the frame of GMT approach, the electromagnetic field in a photonic structure of L nanoparticles can be constructed as a superposition of partial fields scattered from each particle. These partial scattered fields as well as the incident field and internal fields were expanded in the orthogonal basis of vector spherical harmonics represented in local coordinate systems associated with individual particles:

$${E}_{sc}^{l} = {\sum }_{n = 1}^{∞} {\sum }_{m = - n}^{n} ( {a}_{mn}^{l} {N}_{mn} + {b}_{mn}^{l} {M}_{mn} ) , l = 1 , … L \qquad [ 4 ]$$

The use of the powerful addition (translation) theorem for vector spherical harmonics enables the transformation (translation) of the series expansion for the partial fields of the l-th particle into an expansion in the local coordinate system associated with any other particle of the array. A general matrix equation for the Lorenz-Mie multipole scattering coefficients (almn, blmn) can be obtained by imposing the electromagnetic boundary conditions for the tangential components of the electric and magnetic fields and by truncating the infinite series expansions to a maximum multipolar order N:

$$\begin{matrix}{a}_{mn}^{l} + {\tilde{a}}_{n}^{l} {\sum }_{j = l}^{( 1 , L )} {\sum }_{v = 1}^{N} {\sum }_{μ = - v}^{v} ( {A}_{mn μ v}^{jl} {a}_{μ v}^{j} + {B}_{mn μ v}^{jl} {b}_{μ v}^{j} ) = {\tilde{a}}_{n}^{l} {p}_{mn}^{l} \\ {b}_{mn}^{l} + {\tilde{b}}_{n}^{l} {\sum }_{j = l}^{( 1 , L )} {\sum }_{v = 1}^{N} {\sum }_{μ = - v}^{v} ( {B}_{mn μ v}^{jl} {a}_{μ v}^{j} + {A}_{mn μ v}^{jl} {b}_{μ v}^{j} ) = {\tilde{b}}_{n}^{l} {q}_{mn}^{l}\end{matrix} \qquad [ 5 a , 5 b ]$$

Here, Ajlmnμv, Bjlmnμv are the translation matrices, which depend on the distance and direction of translation from origin l to origin j (Mackowski, 1994; Quinten & Kreibig, 1993; Xu, 1995; Kreibig & Vollme, 1995), ãₙ^{l}, \tilde{b}ₙ^{l} are the Mie scattering coefficients of 1-th sphere in the free space (Bohren & Huffman, 1998); and plmn, qlmn are the expansion coefficients of the incident field. Once truncated matrix Eqs. 5 were solved for the scattering coefficients, the scattering, extinction and absorption cross-sections as well as the scattered field distributions can be accurately calculated at any desired level of accuracy. The numerical solution of Eqs. 5 can be obtained with a machine precision if the matrix equation is truncated at a high enough multipolar order.

Image correlation analysis of colorimetric fingerprint. The autocorrelation function (ACF) G(ξ) of a fluctuating spatial signal s(x) that describes the colorimetric fingerprint of nanoparticle arrays was defined as:

G(ξ)=<s(x)s(x+ξ)> [6]

where the angle brackets < > indicate averaging (integration) over the spatial domain. To properly extract quantitative information, the spatial signal was correctly normalized by defining the following quantity (Wiseman & Petersen, 1999):

$$δ s ( x ) = \frac{s ( x ) - 〈 s ( x ) 〉}{〈 s ( x ) 〉} \cdot \qquad [ 7 ]$$

which enables proper definition of the normalized ACF:

$$g ( ξ ) = 〈 δ s ( x ) δ s ( x + ξ ) 〉 = \frac{〈 s ( x ) s ( x + ξ ) 〉 - {〈 s ( x ) 〉}^{2}}{{〈 s ( x ) 〉}^{2}} = \frac{G ( ξ )}{{〈 s ( x ) 〉}^{2}} - 1 \qquad [ 8 ]$$

Analogously, for a colorimetric fingerprint in two-spatial dimensions, s(x,y), the 2D normalized ACF was defined as:

$$g ( ξ , η ) = 〈 δ s ( x , y ) δ s ( x + ξ , y + η ) 〉 = \frac{G ( ξ , η )}{{〈 s ( x , y ) 〉}^{2}} - 1 \qquad [ 9 ]$$

If the colorimetric fingerprint consists of an image with N×M pixels, the discrete implementation of the spatially averaged ACF can be readily obtained as:

$$g ( ξ , η ) = \frac{( 1 / NM ) {\sum }_{k = 1}^{N} {\sum }_{l = 1}^{M} s ( k , l ) s ( k + ξ , l + η )}{{[ ( 1 / NM ) {\sum }_{k = 1}^{N} {\sum }_{l = 1}^{M} s ( k , l ) ]}^{2}} - 1. \qquad [ 10 ]$$

This definition of normalized ACF can obtain the variance of the spatial fluctuations of the colorimetric fingerprints by simple evaluation of the autocorrelation function in the limit when both ξ and η vanish (Wiseman & Petersen, 1999):

$$var δ s ( x , y ) = {lim}_{ξ \to 0} {lim}_{η \to 0} g ( ξ , η ) = g ( 0 , 0 ) \qquad [ 11 ]$$

To perform the ACF calculations more efficiently, the Fourier transform relation (Wiseman & Petersen, 1999, Petersen et al., 1993) was used:

G(ξ,η)=F⁻¹{[F(s(x,y))]*[F*(s(x,y))]} [12] [9]

After G(ξ, η) was obtained from Eq. 12, the normalized ACF was calculated by using Eq. 9. The normalized ACF profiles in one spatial dimension (see, FIG. 8) were extracted from the 2D normalized ACF along the center-line (x axis) of the image and were normalized with respect to the size of the array along the x-direction of the image.

General Principles of Linear Response Theory. The results demonstrated that the colorimetric fingerprints of aperiodic structures with continuous spatial Fourier spectra were very sensitive to small perturbation of the refractive index. This fact, which was proved herein using full vector analytical Mie theory, can be more generally understood based on the general principles of linear response theory for stationary random signals. This theory can provide the general rationale for understanding the scattering properties by rough surfaces in the linear optics regime. The stationary hypothesis on the spatial signal (the scattering surface) was well satisfied in the limit of large samples. In fact, as long as the system's response is linear, the mean square value of the system's output function E[y2] (which in rough surface scattering corresponds to the scattered mean field fluctuations) can be expressed as follows (Newland, “An introduction to random vibrations, spectral and wavelet analysis,” 3rd edition, Dover Publications, New York (2005)):

E[y²]=∫_{-∞}^{+∞}|H(ω)|²Sₓ(ω)dω, [13] [9]

where H(ω) is the linear optical transfer function of the system (frequency response), Sx(ω) is the spectral density of the nanostructured surface (defined by the Fourier transform of its auto-correlation function), and ω is a two-dimensional vector of spatial frequencies. Shown as in Eq. 13, the spectral character, in particular the flatness of the spectral density, of aperiodic arrays directly determines the intensity of the scattered field fluctuations. These fluctuations can be stronger for aperiodic arrays with “diffused” or flat Fourier spectra such as Rudin-Shapiro and Gaussian prime lattices. Therefore, Fourier space engineering of aperiodic arrays can provide a simple tool for the optimization of the scattering response of deterministic aperiodic surfaces and allow the selection the appropriate aperiodic nanostructures of the biophotonic sensor to match specific application needs.

### Example 8

### Capture and/or Measurement of Light Scattered by the Sensor

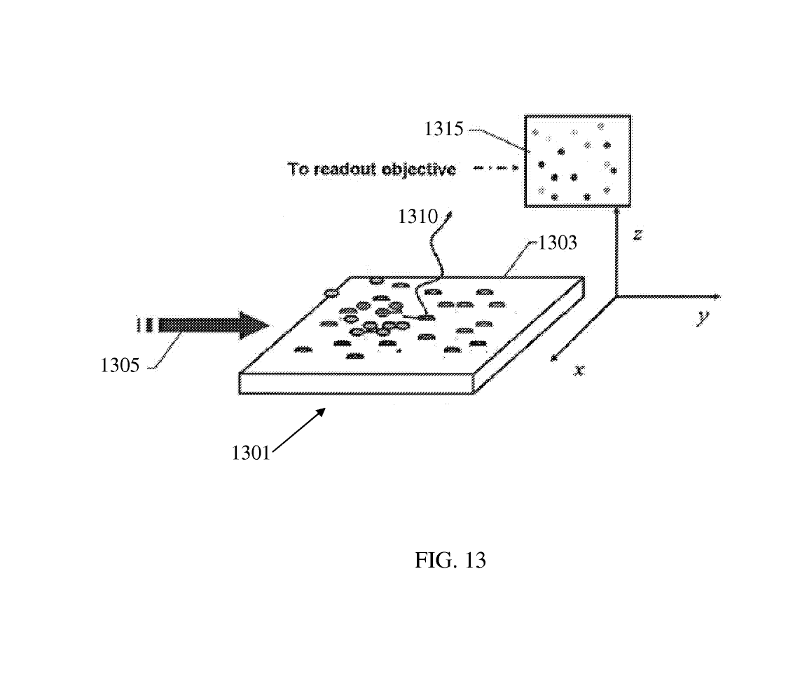

FIG. 13 depicts a colorimetric sensor 1301 with nanostructures arranged in an aperiodic pattern on a surface 1303. In FIG. 13, light 1305 is projected on the sensor at almost grazing incidence (x-y plane). The sensor 1305 may scatter the light, and the scattered light 1310 may be detected perpendicularly along the z axis. The aperiodically arranged nanostructures may produce a spectral signature 1315 that is spatially organized and/or localized regarding color. When an analyte locally alters the refractive index of the surface, the spectral signature may change accordingly.

As depicted in FIG. 13, a sensor 1301 may include a surface 1303 will nanostructures arranged in an aperiodic pattern. The sensor 1301 can be illuminated by a light source wherein the light 1305 is projected at almost a grazing incidence. Scattered colors and/or spatial colorimetric patterns 1315 may appear in light collected from the top. The sensor 1301 can be packaged via enclosure in a compact dark box with two apertures, one for illumination via the light source and one for collection of the scattered light. At the collection aperture, a magnifying objective can enable observation of the colorimetric patterns.

When made with a small size (<1 mm), such surfaces may enable ultra-compact, low-weight colorimetric devices that can be utilized as mass sensors. The surfaces may also enable sensors that detect biochemicals in real-time via color-change, by way of example. The sensor described herein may scatter light according to angular and/or spatially resolved profiles of colors resonantly induced by multiple scattering in the surfaces with aperiodically patterned nanostructures. The local alterations of the refractive index of the surface induced by the patterned structures may induce structured colorimetric signatures in the form of spatially and/or angularly localized scattered fields.

Sensors may be originated by multiple light scattering according to the surface. The scattering may act as a “fingerprint” associated with multi-color diffraction gratings suitable for parallel sensing, where each colored areas of the device can be addressed separately. Quantification of changes in the intensity distribution of scattered light may occur via correlation techniques.

### Example 9

### Fabrication of an Aperiodically Patterned Sensor

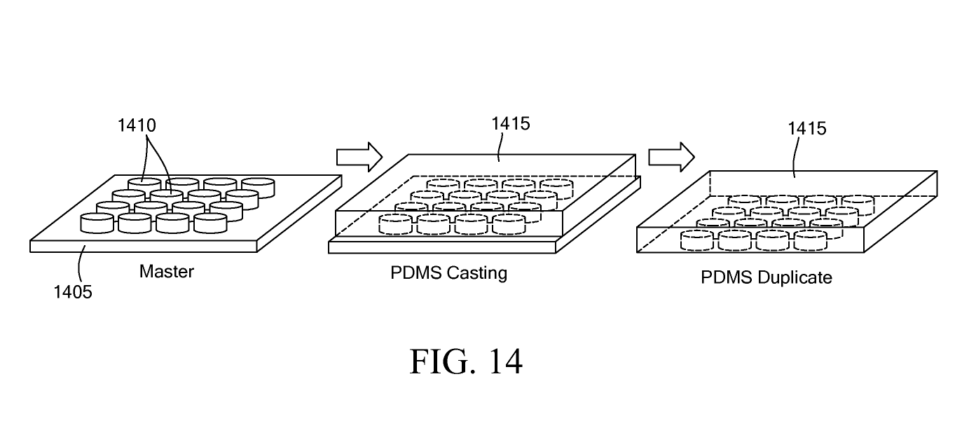

Sensors with structures arranged in aperiodic patterns may be fabricated by e-beam lithography on large areas (e.g., 1 mm²). The patterns may be replicated on soft PDMS and PMMA transparent polymers by room temperature nano-imprinting, by way of example. Referring now to FIG. 14, the replication of sensors with aperiodically patterned nanostructures on PDMS thin films using a pattern transfer process is shown and described. A master pattern 1405 with protrusions 1410 may be fabricated. PDMS may be cast over the master pattern 1405. In some embodiments, a PDMS solution may be cast over the master pattern 1405. As the solution dries, the PDMS may conform to the shapes of the protusions 1405. In some embodiments, a PDMS film 1415 may be contacted with the master pattern 1405. Pressure may be applied between the master pattern 1405 and the PDMS film 1415. The PDMS film 1415 may conform to the shapes of the protusions 1410 in response to the pressure. When the PDMS is removed from the master pattern 1405, the PDMS 1415 may exhibit the pattern corresponding to the arrangement of the protrusions 1410.

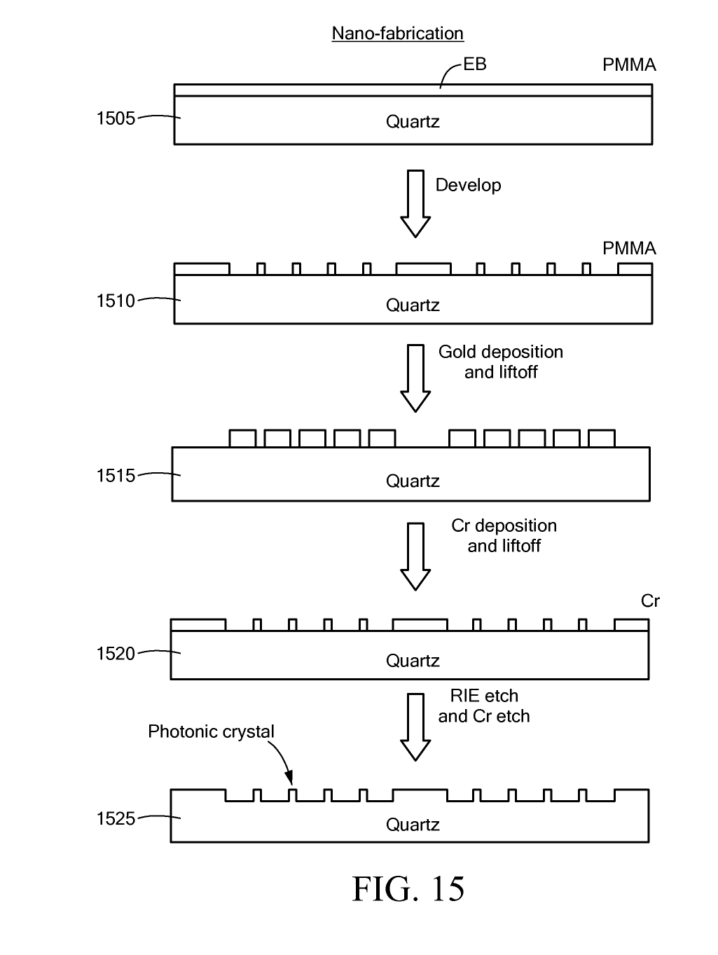

Referring now to FIG. 15, a schematic of a process flow that can be used for hard mask nano-fabrication is shown and described. A photoresist, such as poly(methyl methacrylate) (PMMA) may be spin-coated onto a substrate, such as transparent quartz. Nanostructures may be fabricated on the photoresists via electron beam lithography, by way of example (step 1505). The photoresist may be developed (step 1510). The sensor may be metalized with gold (step 1515). For example, gold may be deposited, and photoresist may be removed from the substrate. The sensor may be metalized with a hard metal, such as chromium (step 1520). For example, chromium may be deposited on the substrate. Reactive ion etching and lift-off may transfer the pattern onto the substrate material (step 1525).

### Example 10

### Aperiodic Patterns

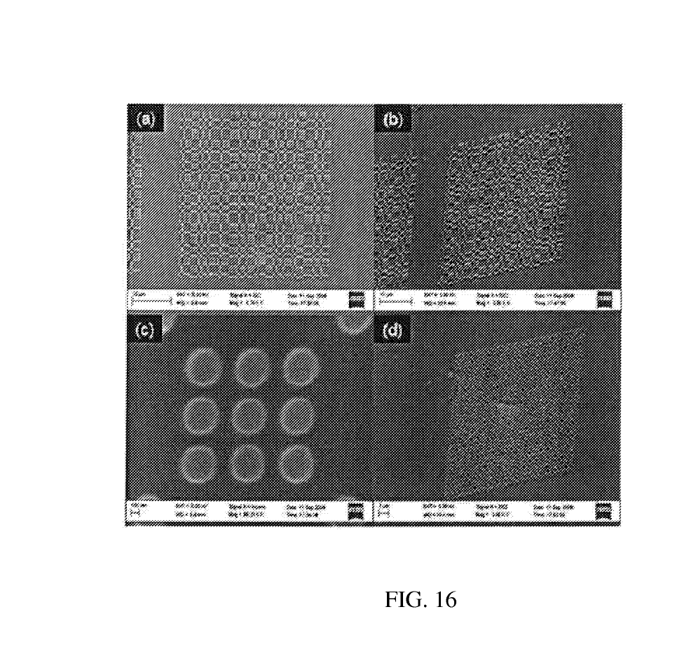

Referring now to FIG. 16, scanning electron microscope (SEM) images (a), (b), (c), and (d) at varying magnifications of PDMS surfaces with nanostructures are shown and described. The PDMS surfaces may include imprinted Rudin-Shapiro aperiodic lattice. Features of the nanostructures on the PDMS surfaces may be as small as about 50 nm. An exemplary feature of a nanostructure may be a dimension of the nanostructure, such as a radius or diameter of a cylindrical structure.

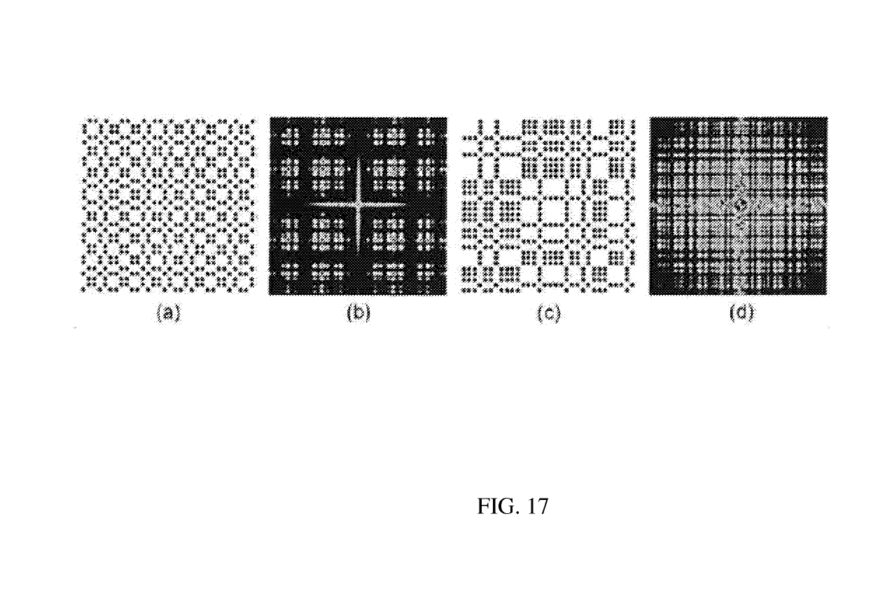

Referring now to FIG. 17, space lattices of Thue-Morse and Rudin-Shapiro 2D photonic structures and their corresponding reciprocal space representations (lattice Fourier spectra) are shown and described. FIGS. 5(a) and (b) depict the space lattice and corresponding reciprocal space representation of a Thue-Morse photonic structure. FIGS. 5(c) and (d) depict the space lattice and corresponding reciprocal space representation of a Rudin-Shapiro 2D photonic structure.

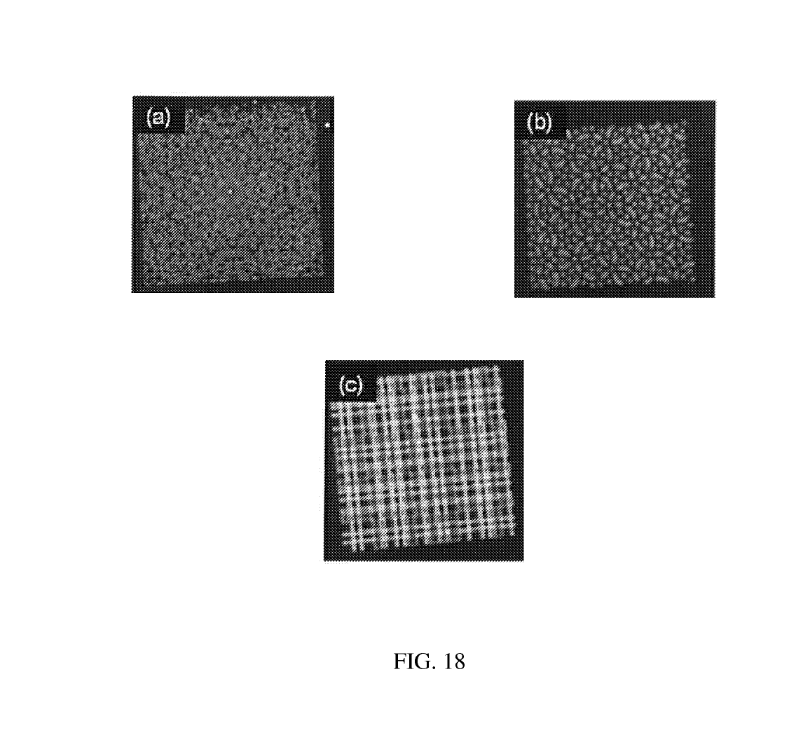

Referring now to FIG. 18, exemplary dark-field images of colorimetric signatures for sensors with aperiodically patterned structures are shown and described. Image (a) of FIG. 18 depicts the spectral signature for a Gaussian prime lattice. Image (b) of FIG. 18 depicts the spectral signature for a Penrose lattice. Image (c) of FIG. 18 depicts the spectral signature for a Rudin-Shapiro lattice. For these images, the sensors were illuminated by white light at grazing incidence, and the spectral signatures were acquired in the perpendicular direction. The images were acquired by a CCD camera using illumination by white light in a dark-field microscope. The images demonstrate the structured color localization for sensors with aperiodically patterned structures. Images (a), (b), and (c) of FIG. 18 thus demonstrate that aperiodically patterned surfaces for sensors may result in patterns of scattered light that are spatially localized and highly organized regarding color. Thus, the patterns may be analyzed for spatial and frequency properties.

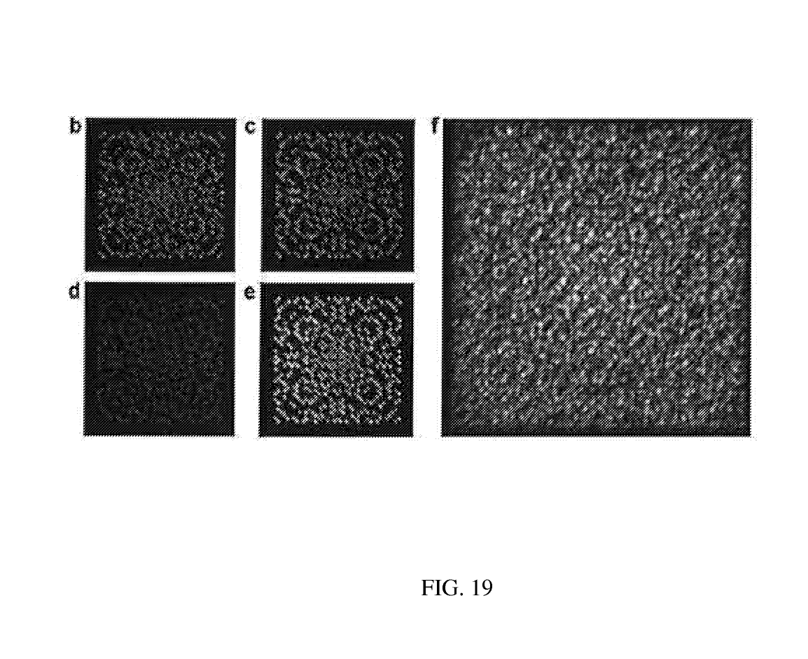

Referring now to FIG. 19, exemplary colorimetric signatures for a sensor with chromium nanospheres (200 nm in diameter, separation of 300 nm between the centers of adjacent spheres) arranged according to a Gaussian prime-based pattern is shown and described. For these signatures, the sensor may be illuminated at 75 degrees to normal. The signatures may correspond to scattered light at the different wavelengths. Image (b) may be a colorimetric signature for light at a wavelength of about 470 nm (blue). Image (c) may be a colorimetric signature for light at a wavelength of about 520 nm (green). Image (c) may be a colorimetric signature for light at a wavelength of about 640 nm (red). Image (e) may be a colorimetric signature for light at wavelengths of about 470 nm (blue), 520 nm (green), and 640 nm (red). Image (f) may be a colorimetric signature for white light.

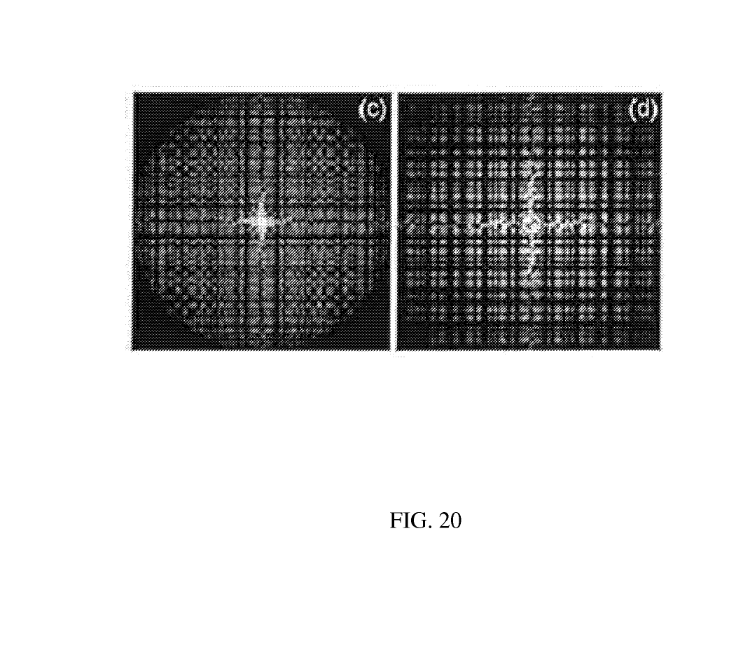

Referring now to FIG. 20, far-field colorimetric signatures of a sensor with nanostructures arranged according to a Rudin-Shapiro pattern are shown. The sensor associated with the signatures includes nano-spheres with diameters of 200 nm. Image (c) of FIG. 20 depicts the Rudin-Shapiro array. Image (d) of FIG. 20 depicts the lattice Fourier transform corresponding to the Rudin-Shapiro array.

### Example 11

### Changes in Spectral Signatures of Sensors in Response to Analytes

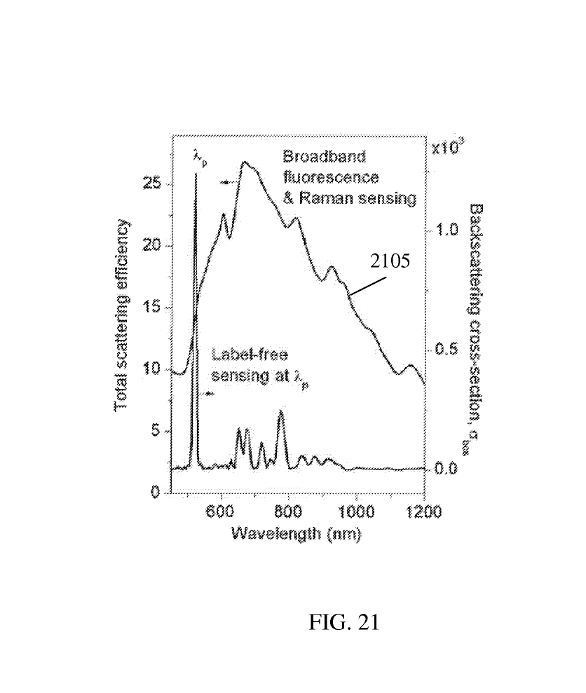

Referring now to FIG. 21, a spectral signature 2105 of a sensor with gold nano-particles (e.g., nano-spheres) arranged according to a Gaussian prime-based pattern is shown. The spectral signature is the signature the sensor exhibits when the sensor has not been exposed to analytes (e.g., a reference signature). The spectral signature may exhibit a peak at a wavelength in the low 500 nm s (e.g., about 520 nm).

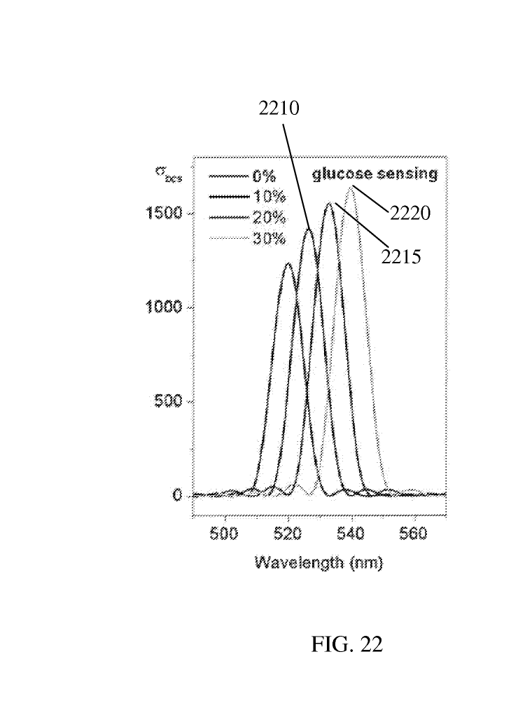

Referring now to FIG. 22, a spectral signature of the same sensor immersed in glucose solutions of varying concentrations is shown and described. As the concentration of the glucose solution increases, the change in the refractive index on the surface of the sensor increases. As the concentration of the glucose solution increases, the frequency shift associated with a resonance peak also increases. For example, when the sensor is immersed in a 10% glucose solution, the resonance peak 2210 may shift from about 520 nm to between 520 and 530 nm. When the sensor is immersed in a 20% glucose solution, the resonance peak 2215 may shift from about 520 nm to between 530 and 540 nm. When the sensor is immersed in a 30% glucose solution, the resonance peak 2220 may shift from about 520 nm to about 540 nm.

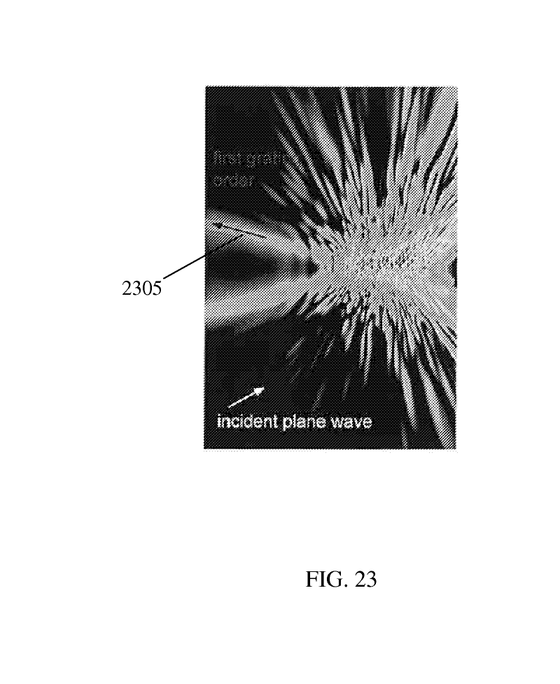

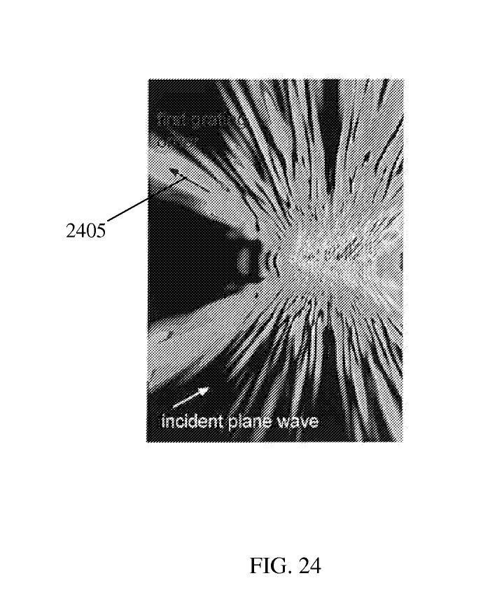

Referring now to FIGS. 23 and 24, patterns of scattered light for a sensor with gold nano-particles (e.g., nano-spheres) arranged according to a Gaussian prime-based pattern are shown and described. A pattern of scattered light for a sensor prior to contact with glucose may be depicted in FIG. 23. The dark arrow 2305 in FIG. 23 may indicate the angular position of light within the angular scattering distribution of the pattern. The sensor may be exposed to a glucose solution. After such exposure, the pattern of light associated with the glucose and sensor combination may scatter light at different angles, as demonstrated by the dark arrow 2405 in FIG. 24.

### Example 12

### Calculation of Variance in Intensity Distribution to Detect an Analyte

Changes in the intensity distribution of light scattered by a sensor may indicate the presence of an analyte. Quantification of the pattern change may be achieved using correlation imaging techniques. In some embodiments, 2D image autocorrelation analysis may reveal changes in the intensity distribution of light scattered by a sensor due to the presence of biological material on the sensor surface. To construct the image autocorrelation function (ACF), the value of the field intensity at point (x, y) in the sensor array plane may be compared with the field intensity at another point (x′, y′). The value may be mapped as a function of the distance between the two points.

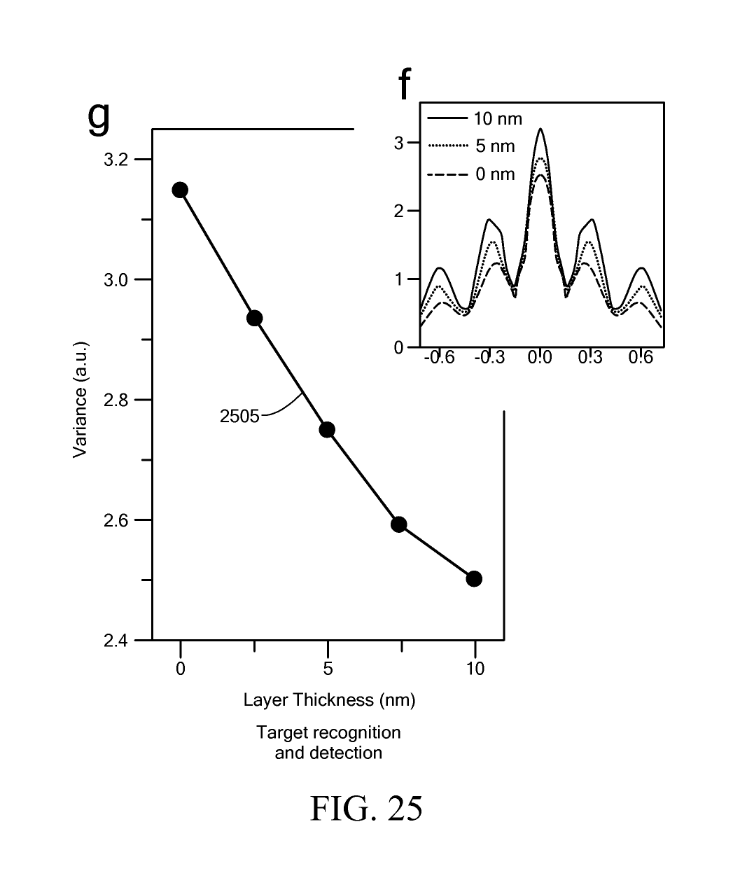

Referring now to FIG. 25, the variance 2505 in the fluctuations of the intensity distribution of scattered light patterns may be plotted as a function of the thickness of a layer of molecules on the sensor. The scattered light patterns may correspond to a sensor with nanostructures arranged in a Gaussian prime-based pattern. The variance may be the value of the properly normalized discrete ACF in the limit of zero lateral displacements. The absorption of a 2.5 nm-thin low-index dielectric (n=1.5) layer on the surface of the sensor results in the 6.6% change in the absolute value of the intensity pattern variance. Thus, the sensor may sense thickness changes in the nanometer and/or sub-nanometer range.

1. An apparatus comprising:
a substrate comprising a patterned surface having aperiodic nanostructured protrusions; and
a silk material deposited between the protrusions;
wherein a spectral signature of the apparatus exhibits a change when the apparatus is exposed to an analyte.

2. The apparatus of claim 1, wherein the change in the spectral signature is
(a) a frequency shift of a peak in the spectral signature;
(b) a color change in the visible spectrum;
(c) a frequency shift of at least a portion of the spectral signature in a visible spectrum;
(d) a change in variance of a correlation function applied to the spectral signature; or,
(e) any combinations of (a), (b), (c) and (d) above.

3-5. (canceled)

6. The apparatus of claim 2, wherein the correlation function is an autocorrelation function.

7. The apparatus of claim 2, wherein the correlation function is a two-dimensional, normalized autocorrelation function.

8. The apparatus of claim 1, wherein the pattern is deterministic.

9. The apparatus of claim 1, wherein the pattern is determined according to a Thue-Morse sequence, a Rudin-Shapiro sequence, a Fibonacci sequence, a prime number sequence, or a Penrose tiling.

10. The apparatus of claim 1, wherein the protrusions are nano-pillars, particles, or combination thereof.

11. (canceled)

12. The apparatus of claim 1, wherein a height of each of the protrusions is about 40 nm.

13. The apparatus of claim 1, wherein a radius of each of the protrusions is about 100 nm.

14. The apparatus of claim 1, wherein a distance between centers of adjacent protrusions is between about 300 nm and 400 nm.

15. The apparatus of claim 1, wherein the protrusions comprise chromium.

16. The apparatus of claim 1, wherein a thickness of the silk material is between about 1 nm and about 20 nm.

17. The apparatus of claim 1, wherein the silk material comprises an agent which interacts with the analyte.

18. The apparatus of claim 1, wherein the spectral signature of the apparatus exhibits the change when exposed to between about 10⁻¹² M and about 10⁻¹⁸ M of the analyte.

19. A method for analyzing a sample, the method comprising steps of:
providing a biophotonic sensor unit, which comprises a patterned surface having aperiodic nanostructured protrusions and a silk material deposited between the protrusions of the patterned surface;
contacting the biophotonic sensor unit with a sample;
illuminating the biophotonic sensor unit with a light source to generate a signal, wherein the signal is a pattern of scattered light;
analyzing the signal based on at least one optical parameter to produce a datum; and,
comparing the datum with a reference datum;
wherein the difference between the datum and the reference datum provides analytical information on the sample.

20. The method of claim 19, wherein the analytical information
(a) indicates the presence or absence of an analyte;
(b) is relative amounts of an analyte;
(c) is change in an analyte; or,
(d) any combinations of (a), (b) and (c) above.

21-22. (canceled)

23. The method of claim 19, wherein one or more steps include parallel processing.

24. The method of claim 23, wherein the parallel processing is performed on a chip, wherein the chip comprises a plurality of biophotonic sensor units.

25. The method of claim 24, wherein the plurality of biophotonic sensor units are arranged in an array on the chip.

26. The method of claim 19, wherein the light source comprises white light.

27. The method of claim 19, wherein the at least one optical parameter is color, frequency, intensity distribution, or angular distribution.

28. The method of claim 19, wherein the silk material further incorporates an agent.

29. The method of claim 19, wherein the agent interacts with an antibody, an antigen, a hormone, a cytokine, a growth factor, or a pathogen.

30. The method of claim 20, wherein the analyte is an antibody, antigen, toxin, or an infectious agent.

31. The method of claim 19, wherein the datum is a location of a peak in the spectral signature; a color change in the signal; a variance of secondary data produced by applying a correlation function to the signal; a variance of secondary data produced by applying an autocorrelation function to the signal; or a variance of secondary data produced by applying a two-dimensional, normalized autocorrelation function to the signal.


SEQUENCE LISTING (22 sequences)

SEQ ID NO: 1 - protein, 90 aa, Artificial sequence
  Synthetic polypeptide
GAGAGSGAGAGSGAGAGSGAGAGSGAGAGSGAGAGSGAGAGSGAGAGSGAGAGSGAGAGSGAGAGSGAGAGSGAGAGSGAGAGSGAGAGS

SEQ ID NO: 2 - protein, 30 aa, Artificial sequence
  Synthetic polypeptide
GXGXGXGXGXGXGXGXGXGXGXGXGXGXGX

SEQ ID NO: 3 - protein, 4 aa, Bombyx mori
GAAS

SEQ ID NO: 4 - protein, 15 aa, Artificial sequence
  Synthetic polypeptide
SSAAAAAAAAAAAAA

SEQ ID NO: 5 - protein, 8 aa, Artificial sequence
  Synthetic polypeptide
GXXXXGGX

SEQ ID NO: 6 - protein, 4 aa, Artificial sequence
  Synthetic polypeptide
GGGX

SEQ ID NO: 7 - protein, 12 aa, Artificial sequence
  Synthetic polypeptide
SSAAAASSAAAA

SEQ ID NO: 8 - protein, 6 aa, Galleria mellonella
GLGGLG

SEQ ID NO: 9 - protein, 6 aa, Artificial sequence
  Synthetic polypeptide
GXGGXG

SEQ ID NO: 10 - protein, 21 aa, Artificial sequence
  Synthetic polypeptide
GPGGXGPGGXGPGGXGPGGXY

SEQ ID NO: 11 - protein, 5 aa, Argiope trifasciata
GRGGA

SEQ ID NO: 12 - protein, 13 aa, Artificial sequence
  Synthetic polypeptide
GAGAAAAAAAGGA

SEQ ID NO: 13 - protein, 8 aa, Artificial sequence
  Synthetic polypeptide
GGXGXGXX

SEQ ID NO: 14 - protein, 16 aa, Bombyx mori
TGSSGFGPYVNGGYSG

SEQ ID NO: 15 - protein, 8 aa, Bombyx mandarina
YEYAWSSE

SEQ ID NO: 16 - protein, 7 aa, Antheraea mylitta
SDFGTGS

SEQ ID NO: 17 - protein, 7 aa, Antheraea yamamai
RRAGYDR

SEQ ID NO: 18 - protein, 8 aa, Galleria mellonella
EVIVIDDR

SEQ ID NO: 19 - protein, 18 aa, Nephila madascariensis
TTIIEDLDITIDGADGPI

SEQ ID NO: 20 - protein, 8 aa, Major ampullata
TISEELTI

SEQ ID NO: 21 - protein, 6 aa, Artificial sequence
  Synthetic polypeptide
GSGAGA

SEQ ID NO: 22 - protein, 5 aa, Artificial sequence
  Synthetic polypeptide
GPGXX